(19) United States
(12) Patent Application Publication
(10) Pub. No.: US 2020/0159895 A1
(43) Pub. Date: May 21, 2020

(54) INFORMATION PROCESSING DEVICE, INFORMATION PROCESSING METHOD, AND PROGRAM

(71) Applicant: SONY CORPORATION, TOKYO (JP)

(72) Inventor: TAKASHI OGATA, TOKYO (JP)

(21) Appl. No.: 16/611,251

(22) PCT Filed: Apr. 25, 2018
(86) PCT No.: PCT/JP2018/016777

§ 371 Date: Nov. 6, 2019

(30) Foreign Application Priority Data
Jun. 14, 2017 (JP) 2017-116561
Jan. 31, 2018 (JP) 2018-015074

(51) Int. Cl. G06F 21/31; G06N 20/00

(52) U.S. Cl. CPC G06F 21/316; G06N 20/00

(57) ABSTRACT

[Overview] [Problem to be Solved] It is possible to achieve accurate user authentication by a simpler method. [Solution] There is provided an information processing device including an authentication unit that authenticates a user on the basis of information regarding carried states of two or more devices by the user. The information is acquired from the devices.

### TECHNICAL FIELD

The present disclosure relates to an information processing device, an information processing method, and a program.

### BACKGROUND ART

In recent years, sensors have been consuming less power and miniaturized, which has allowed the sensors to be installed in various articles. In addition, compact tag devices including sensors have been developed, and users have been able to attach the tag devices to desired articles. Then, various kinds of technology using the sensing data acquired by those sensors have been developed.

For example, PTL 1 below discloses technology of grasping the current state of a user on the other end of the line by using sensing data, and performing various kinds of processing according to the state. In addition, for example, technology is also disclosed of performing user authentication by using sensing data like fingerprint authentication and iris authentication.

### CITATION LIST

### Patent Literature

PTL 1: Japanese Unexamined Patent Application Publication No. 2006-345269

### SUMMARY OF THE INVENTION

### Problems to be Solved by the Invention

However, it is sometimes difficult to achieve accurate authentication for user authentication by a simple method. For example, in a case where user authentication is performed by fingerprint authentication or iris authentication, a user has considerable trouble because the user has to perform a predetermined operation (such as an operation of bringing a finger into contact with a fingerprint information acquisition unit, or an operation of causing an imaging unit to capture an image of an iris).

Accordingly, the present disclosure results from the above, and provides a novel and improved information processing device, information processing method, and program that make it possible to achieve accurate user authentication by a simpler method.

### Means for Solving the Problems

According to the present disclosure, there is provided an information processing device including an authentication unit that authenticates a user on the basis of information regarding carried states of two or more devices by the user. The information is acquired from the devices.

In addition, according to the present disclosure, there is provided an information processing method that is executed by a computer. The information processing method includes authenticating a user on the basis of information regarding carried states of two or more devices by the user. The information is acquired from the devices.

In addition, according to the present disclosure, there is provided a program for causing a computer to implement authenticating a user on the basis of information regarding carried states of two or more devices by the user. The information is acquired from the devices.

### Effects of the Invention

As described above, according to the present disclosure, it is possible to achieve accurate user authentication by a simpler method.

It should be noted that the above-described effects are not necessarily limiting. Any of the effects indicated in this description or other effects that can be understood from this description may be exerted in addition to the above-described effects or in place of the above-described effects.

### BRIEF DESCRIPTION OF DRAWING

FIG. 1 is an image diagram illustrating an overview of the present disclosure.

FIG. 2 is an image diagram illustrating the overview of the present disclosure.

FIG. 3 is a block diagram illustrating an example of a functional component of a device.

FIG. 4 is a flowchart illustrating an example of a carrying recognition operation.

FIG. 5 is a flowchart illustrating an example of a simpler carrying recognition operation.

FIG. 6 is a flowchart illustrating an example of a carried-position recognition operation.

FIG. 7 is a flowchart illustrating an example of a simpler carried-position recognition operation.

FIG. 8 is a flowchart illustrating an example of a same-person carrying recognition operation.

FIG. 9 is a flowchart illustrating an example of a simpler same-person carrying recognition operation.

FIG. 10 is a flowchart illustrating an example of a carrying-person recognition (user authentication) operation.

FIG. 11 is a diagram illustrating an image of carrying-person score calculation.

FIG. 12 is a diagram illustrating an image of the carrying-person score calculation.

FIG. 13 is a flowchart illustrating an example of a simpler carrying-person recognition (user authentication) operation.

FIG. 14 is a diagram illustrating an overview of person relevance recognition.

FIG. 15 is a flowchart illustrating an example of a person relevance recognition operation.

FIG. 16 is a flowchart illustrating an example of group confirmation and a subsequent operation.

FIG. 17 is a flowchart illustrating an example of the group confirmation and subsequent operation.

FIG. 18 is a flowchart illustrating an example of operations of action prediction and carrying recommendation.

FIG. 19 is a diagram illustrating an example of an action history list.

FIG. 20 is a diagram illustrating an example of a carried-device list.

FIG. 21 is a flowchart illustrating an example of an operation regarding evaluation of a state of the device.

FIG. 22 is a diagram illustrating an image of a device state score.

FIG. 23 is a diagram illustrating an example in which the device is ranked on the basis of the device state score.

FIG. 24 is a flowchart illustrating an example of an operation of calculating a user article use score.

FIG. 25 is a diagram illustrating an example of UI (User Interface) used to manage the device.

FIG. 26 is a diagram illustrating an example of the UI used to manage the device.

FIG. 27 is a diagram illustrating an example of the UI used to manage the device.

FIG. 28 is a diagram illustrating an example of the UI used to manage the device.

FIG. 29 is a diagram illustrating an example of the UI used to manage the device.

FIG. 30 is a diagram illustrating an example of the UI used to manage the device.

FIG. 31 is a diagram illustrating an example of UI used to recommend a device that should be carried.

FIG. 32 is a diagram illustrating an example of the UI used to recommend the device that should be carried.

FIG. 33 is a diagram illustrating an example of UI used for a notification of an object left behind.

FIG. 34 is a diagram illustrating an example of UI used for a notification of an object left behind and unlocking.

FIG. 35 is a diagram illustrating an example of UI that indicates a situation of user authentication.

FIG. 36 is a diagram illustrating an example of the UI that indicates the situation of user authentication.

FIG. 37 is a diagram illustrating an example of UI that displays a selling price or the like of the device.

FIG. 38 is a diagram illustrating an example of UI that allows a user to confirm the user article use score or the like of the user himself or herself.

FIG. 39 is a diagram illustrating an example of UI that allows the user to confirm device state scores or the like regarding all devices used in past.

### MODES FOR CARRYING OUT THE INVENTION

The following describes a preferred embodiment of the present disclosure in detail with reference to the accompanying drawings. It should be noted that, in this description and the accompanying drawings, constituent elements that have substantially the same functional configuration are indicated by the same reference signs, and thus redundant description thereof is omitted.

It should be noted that the description is given in the following order.

### 1. Background

### 2. Overview of the Present Disclosure

### 3. Functional Component of Device

### 4. Operation of Device

### 5. Various UI

### 6. Conclusion

### 1. BACKGROUND

First, the background of the present disclosure is described.

As described above, in recent years, sensors have been consuming less power and miniaturized, which has allowed the sensors to be installed in various articles. In addition, compact tag devices including sensors have been developed, and users have been able to attach the tag devices to desired articles. Then, various kinds of technology using the sensing data acquired by those sensors have been developed. For example, technology is disclosed of performing user authentication by using sensing data like fingerprint authentication and iris authentication.

Here, it is sometimes difficult to achieve accurate user authentication by a simple method for user authentication using various sensors. For example, in a case where user authentication is performed by fingerprint authentication or iris authentication, a user has considerable trouble because the user has to perform a predetermined operation (such as an operation of bringing a finger into contact with a fingerprint information acquisition unit, or an operation of causing an imaging unit to capture an image of an iris). In addition, there is a function of unlocking a smartphone in a case where a sensor detects that the user is carrying the smartphone, by assuming that the user has been authenticated until the carried state is terminated. In this case, if a third person acquires the smartphone from the moving user, the third person is able to freely operate the smartphone. From the above, it is desired to achieve accurate user authentication by a simpler method.

In addition, action prediction is sometimes performed using various sensors. For example, future-action prediction is performed for a user in some cases on the basis of sensing data from a GNSS sensor and a past action history of the user. In this case, the user has to move to a considerable degree to allow for action prediction. Thus, in a case where the user is notified of an object left behind or the like on the basis of the action prediction, the timing of the notification is delayed in some cases (e.g., it is difficult to issue a notification before the user leaves the house). In addition, in a case where the place to which the user goes for a predetermined purpose is not much apart from the place to which the user goes for another purpose, it is not possible for the action prediction using a GNSS sensor to determine a difference between the purposes. This sometimes leads to failure in proper action prediction.

In addition, managing various articles including sensors sometimes requests a heavy load from a user. For example, in a case where a tag device including a sensor is attached to an article desired by a user, the user is sometimes requested to input information regarding the article (such as an attribute of the article) into a predetermined device. In addition, when a user starts to use various articles including sensors, the user is sometimes requested to input (authenticate) the user as the owner of the articles. In these cases, a user who is not used to an input operation sometimes takes a considerable amount of time to make an input or makes an erroneous input.

In addition, various services have been recently gaining widespread use that allow individuals to buy and sell via the Internet or the like. Further, a sharing economy service has been popular that makes it possible to share articles, places, or the like with a plurality of people. The states of the articles or the like handled in these services have not been sometimes evaluated properly in the past.

For example, salespersons of secondhand stores evaluate articles only on the basis of the states of articles at the time, but are unable to take, into consideration, history information or the like of the handled articles in many cases in the secondhand market including transactions between individuals. The evaluation accuracy thus depends on the skills of salespersons, etc., and is not stable. For example, salespersons or stores are different from each other in evaluation accuracy. In addition, when a used product is sold, the state of the used product is displayed by a method unique to a store. For example, the state of a used product is ranked and displayed like “A rank,” “B rank,” or the like, or qualitative and subjective features are displayed like “beautiful,” “scratched,” “dirty,” or the like. These kinds of display are different for each store, and the evaluation criteria are also different. For this reason, especially in a case where a purchaser is not able to confirm an actual product as in the case of buying and selling via the Internet, the purchaser is not sometimes able to determine, just by seeing the display, whether or not to purchase.

In addition, in a shared economy service, lenders are not able to know in advance how borrowers handle the lent articles. Accordingly, the lenders are not able to properly evaluate the risks of lending articles to the borrowers. Thus, for example, if a lender overestimates the risks and buys excessive insurance, the lender may lose the profits. Alternatively, higher rental price may cause a lender to fail to make a deal with a borrower, and lose an opportunity. In contrast, if a lender underestimates the risks, the damage to the lent article may not be fully compensated. From a borrower's point of view, for example, in a case where the borrower is a user who carefully handles an article, but the risks is overestimated, the borrower may have to pay high rental price.

Further, a borrower and an actual user may be different from each other. For example, a borrower may sometimes borrow an article, and then allow another person to use the article (i.e., the borrower subleases the article). In this case, in a case where the actual user is a user who carelessly handles the article, the article may be damaged more than the lender expects.

In view of the above circumstances, the present discloser has conceived of the present technology. The following describes the technology according to the present disclosure in detail.

### 2. OVERVIEW OF THE PRESENT DISCLOSURE

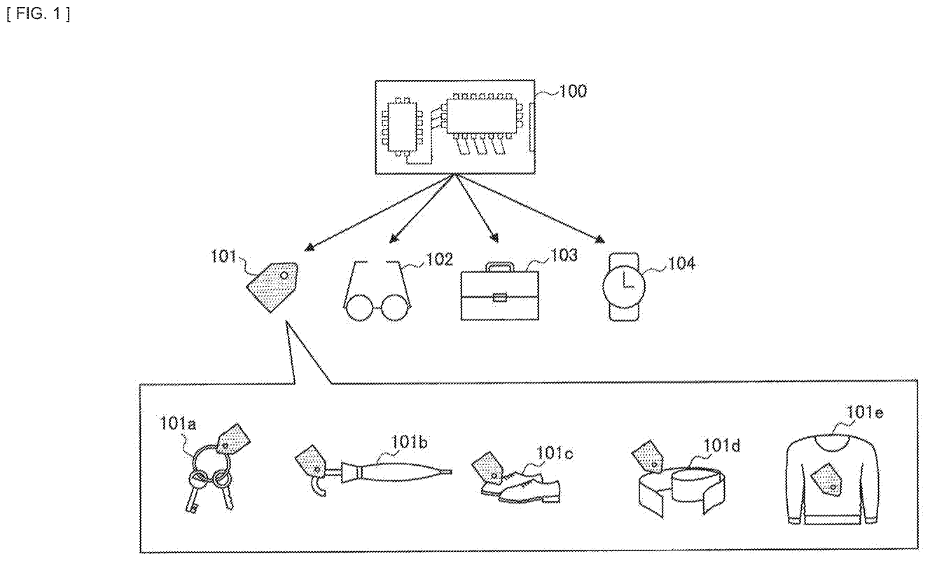

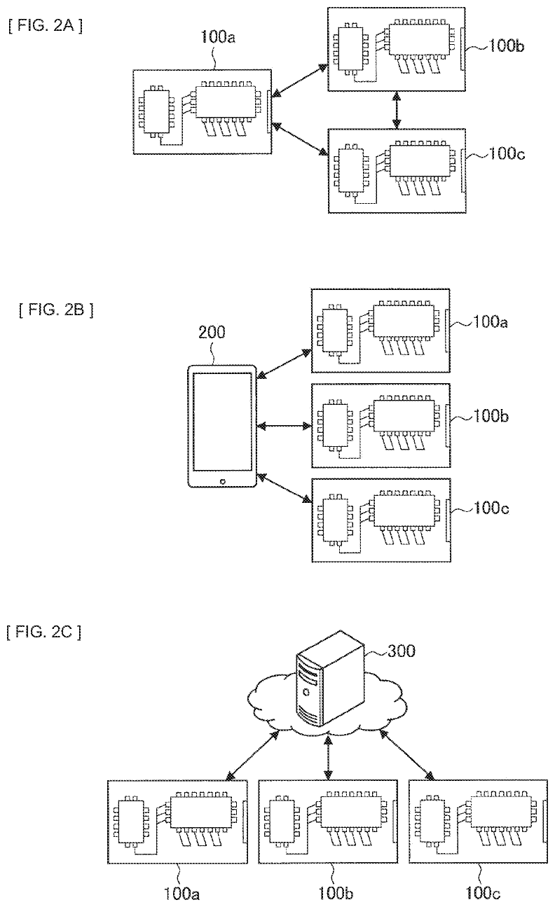

The background of the present disclosure has been described above. Next, the overview of the present disclosure is described with reference to FIGS. 1 and 2.

The present disclosure is achieved by a device (referred to as “device 100” below) that is an information processing device having a sensor function and a communication function. The device 100 is an information processing device that has the function of, for example, an acceleration sensor, a gyro sensor, a GNSS sensor, or the like, and is able to perform user authentication or the like on the basis of sensing data thereof. Note that the above demonstrates merely examples, and the device 100 has any sensor function. For example, the device 100 may have any sensor function such as a geomagnetic sensor, an atmospheric pressure sensor, a temperature sensor, a vibration sensor, an audio sensor, a heart rate sensor, a pulse wave sensor, a proximity sensor, an illuminance sensor, a pressure sensor, a perspiration sensor, a pH sensor, a humidity sensor, or an infrared sensor as long as the sensor function makes it possible to capture a physical change, a chemical change, or the like caused by a motion of the human.

The device 100 is assumed to be a device that is small enough to be incorporated in or attached to a variety of articles. For example, as illustrated in FIG. 1, the device 100 may be incorporated in an article such as glasses 102, a bag 103, or a watch 104, or a tag device 101 in which the device 100 is incorporated may be attached to a key 101a, an umbrella 101b, shoes 101c, a belt 101d, clothes 101e, or the like. Note that the above demonstrates merely examples, and the size of the device 100, an article in which the device 100 is incorporated, and an article to which the device 100 is attached are not particularly limited. In addition, FIG. 1 illustrates the device 100 in the shape of an IC chip, but the shape of the device 100 is not particularly limited.

In addition, the device 100 having a communication function is able to communicate with various devices. For example, as illustrated in FIG. 2, the device 100 may wirelessly communicate with another device 100 (see 2A, which exemplifies devices 100a to 100c), any information processing device 200 (see 2B, which exemplifies a smartphone 200), or an information processing device 300 on a predetermined network (see 2C, which exemplifies a server 300 on a cloud network). Note that FIG. 2 illustrates merely an example, and a communication mode other than the communication mode illustrated in FIG. 2 may be used. This specification describes, as an example, a case where the device 100 wirelessly communicates with each of the other devices 100 as illustrated in 2A to achieve various functions according to the present disclosure.

The device 100 according to the present disclosure is able to perform user authentication on the basis of information regarding the carried states of the two or more devices 100 by a user. The information is acquired from the devices 100. For example, the device 100 is able to authenticate a user on the basis a combination or the like of the devices 100 carried by the user.

More specifically, in a case where a user carries the device 100, the device 100 recognizes that the own device is being carried, on the basis of various sensors (such as an acceleration sensor and a gyro sensor) included in the own device. Then, in a case where a user carries the two or more devices 100, the respective devices 100 wirelessly communicate with each other to recognize that the respective devices 100 are being carried. The device 100 is then able to perform user authentication on the basis of the correlation between a user to be authenticated and a user in history information (referred to as “carried-history information” below) on the basis of the carried-history information. The carried-history information is obtained when the device 100 has been carried in the past.

This allows the device 100 to achieve accurate user authentication by a simpler method. More specifically, as described above, user authentication is performed on the basis of the carried-history information of the device 100 by a user. Accordingly, the device 100 is able to achieve more accurate user authentication as compared with the function of unlocking a smartphone or the like by assuming that a user has been authenticated while the smartphone is carried by the user. In addition, user authentication is performed just by a user carrying the device 100 as usual in the present disclosure. Accordingly, as compared to fingerprint authentication or iris authentication that requests a predetermined operation (such as an operation of bringing a finger into contact with a fingerprint information acquisition unit, or an operation of causing an imaging unit to capture an image of an iris) for user authentication, the device 100 is able to achieve user authentication by a simpler method.

In addition, the device 100 is able to perform user authentication by taking, into consideration, even the carrying method of each device 100 by a user. More specifically, the device 100 recognizes the carrying method of each device 100 by a user on the basis of various sensors (such as an acceleration sensor and a gyro sensor). Here, the “carrying method” indicates various modes in which the device 100 is carried. For example, the device 100 recognizes the holding mode (e.g., worn on a portion of a body (such as a face, an ear, a neck, a hand, an arm, a waist, or a foot), or put in a pocket (such as a chest pocket, or a front or back pocket of pants) or a bag (such as a shoulder bag, a backpack, or a tote bag)) of each device 100, and the movement method (walking, running, riding on various vehicles (such as a bicycle, an automobile, a bus, a train, a vessel, and an airplane)) of a user carrying each device 100. Then, the device 100 also adds the element of the carrying method of each device 100 when calculating the correlation between a user to be authenticated and a user in the carried-history information. This allows the device 100 to further improve the accuracy of user authentication.

Note that the above demonstrates merely examples, and the user authentication method is not particularly limited. More specifically, the information used for user authentication is not limited to a combination of the devices 100 and the carrying methods thereof, but may include any information indicating the relationship between the carried states of the respective devices 100. For example, the device 100 may perform user authentication on the basis of the timing, order, or the like for a user to carry each device 100. The device 100 is able to further improve the accuracy of user authentication in a case where the timing, order, or the like for each device 100 to be carried has user-specific tendency.

In addition, the device 100 is also able to predict an action of a user on the basis of information regarding the carried states of the two or more devices 100 by the user. The information is acquired from the devices 100. For example, the device 100 is able to predict an action of a user on the basis a combination of the devices 100 carried by the user. More specifically, the device 100 stores a plurality of actions and a combination of the devices 100 at the time of performing the respective actions in association with each other as the carried-history information. The device 100 then calculates the correlation value of the combination of the devices 100 carried by the user and the combination of the devices 100 at the time of performing the respective actions in the carried-history information. The device 100 is able to predict an action of the user on the basis of the correlation value.

This allows the device 100 to perform action prediction at earlier timing. More specifically, in a case where a GNSS sensor or the like is used for action prediction, the action prediction is not accurately performed before a user moves to a considerable degree. In contrast, the device 100 is able to perform action prediction at the time when a user carries each device 100 (or in the process of carrying each device 100). This makes it possible to perform action prediction at earlier timing.

In addition, the device 100 is sometimes able to further improve the prediction accuracy as compared with action prediction based on a GNSS sensor or the like. For example, the action prediction based on a GNSS sensor or the like sometimes exhibits a decrease in the prediction accuracy of a user action in a case where the place to which a user goes for a predetermined purpose (e.g., office for work, etc.) is not much apart from the place to which the user goes for another purpose (e.g., leisure facilities). In addition, in a case where a user goes to different places for the same purpose (e.g., in a case where the user goes to different offices every time), the prediction accuracy of a user action sometimes decreases similarly. Meanwhile, a user carries different articles depending on purposes (e.g., an article that is carried when the user goes to the office is different from an article that is carried when the user goes to the leisure facilities). Accordingly, the device 100 is sometimes able to more accurately predict an action of the user. Note that the above demonstrates merely examples, and the action prediction method is not particularly limited. For example, similarly to the above, the device 100 may perform action prediction by taking, into consideration, the carrying methods of the respective devices 100, the timing or order for the devices 100 to be carried, or the like.

In addition, the device 100 may perform various kinds of processing on the basis of an action prediction result. For example, the device 100 may notify a user of an excess or deficiency of the carried devices 100 (e.g., objects left behind, unnecessary objects, etc.). More specifically, the device 100 stores an action of a user and an object carried at the time of each action in association with each other as the carried-history information. The device 100 then calculates, on the basis of the carried-history information and the action prediction result, the device 100 (referred to as “recommendation device 100” below) that seems desirable for the user to carry, and compares the recommendation device 100 with the device 100 that is actually carried. This makes it possible to notify the user of an excess or deficiency of the devices 100. Note that the above demonstrates merely examples, but the contents of the processing performed on the basis of the action prediction result is not limited to the above.

In addition, in a case where two or more users share the device 100, the device 100 is able to recognize that the respective users belong to a common group (such as family, close friends, circle members, or co-workers). The device 100 is then able to recognize the degree of the relevance (or reliability, etc.) between the respective users on the basis of the sharing situation of each device 100. For example, the device 100 is able to recognize the degree of the relevance between the respective users in accordance with the importance of each device 100 shared among users, the number of shared devices 100, or the like. More specifically, the device 100 is able to recognize that the respective users have higher relevance with an increase in the importance of each device 100 shared among users or with an increase in the number of shared devices 100. Note that the device 100 is able to recognize not only the degree of relevance, but also an attribute or the like of a group. For example, in a case where a “house key” is shared by two or more users, the device 100 is able to be recognize that the respective users are a family (the respective users belong to a group having the attribute “family”).

In addition, the device 100 is able to recognize a category of the own device (or a device to which the device 100 is attached). Here, the “category” is a concept indicating the type of the device 100 (e.g., “glasses”, “bags”, “watches”, “umbrellas”, “shoes”, “belts”, “clothes”, etc.), the owner of the device 100 (such as “things of father” or “things of A (personal name)”), the owner group of the device 100 (such as “things of family” or “things of B organization”), the application or purpose of the device 100 (such as “tennis set”, “work set” or “evacuation set”), the period, time or place for the device 100 to be used (such as “things used in winter”, “things used from C month to D month”, “things used in the morning”, “things used from E o'clock to F o'clock”, or “things used at home”), or the like. Note that the above demonstrates merely examples, and the contents of a category are not particularly limited to the above. In addition, a plurality of categories may be set for the one device 100. For example, in a case where the device 100 is attached to a father's coat, “clothes (coat)”, “things of father”, “things of family”, “things used in winter” and the like may be set as categories.

In addition, in a case where the device 100 does not recognize a category of the own device (e.g., immediately after the device 100 is purchased, immediately after the device 100 is attached to a predetermined article, or the like), the device 100 is also able to recognize a category of the own device on the basis of the carried state of the device by a user. More specifically, the device 100, for example, compares the carried-history information of each device 100 obtained by communicating with the other device 100 having a known category with the carried-history information of the own device, thereby allowing a category of the own device to be recognized. For example, in a case where the device 100 is shoes (or the device 100 attached to shoes), the device 100 is able to recognize a category of the own device as “shoes” on the basis of the similarity between the carried-history information of other shoes and the carried-history information of the own device. Note that the device 100 may recognize “things of father”, “tennis set (tennis shoe)”, and the like, which are categories other than “shoes”.

This may reduce the load on a user to manage each device 100. In other words, even if the user does not register various kinds of information such as a category regarding the device 100, each device 100 is able to recognize various kinds of information regarding the own device on its own initiative.

In addition, the device 100 is able to perform various operations on the basis of a category of the own device. For example, the device 100 is able to acquire the carried-history information from the other device 100 having the same category or a category in a predetermined relation. More specifically, in a case where there is little carried-history information of the device 100 (e.g., immediately after the device 100 is purchased, immediately after the device 100 is attached to a predetermined article, or the like), the device 100 may acquire the carried-history information of the other device 100 having the same category or a category in a predetermined relation (e.g., relation of high relevance), thereby using it for the various kinds of processing described above such as user authentication and action prediction. This allows the device 100 to effectively use the carried-history information of the other device 100 even in a case where there is little carried-history information of the own device. In addition, the device 100 may determine a communication target on the basis of a category of the own device. For example, in a case where the device 100 has the category “things of family”, the device 100 having the same category “things of family” among the other devices 100 may be determined as a communication target. This makes it possible to prevent the device 100 from communicating with the device 100 of an unrelated third person.

In addition, the device 100 is able to properly evaluate the state of the device 100 by storing the past use situation by a user. More specifically, the device 100 recognizes how the own device is handled, on the basis of various sensors (e.g., an acceleration sensor, a gyro sensor, etc.) included in the own device. For example, the device 100 recognizes the presence or absence, or degree of an event such as vibration, rotation, submersion, disassembly or modification on the basis of various sensors. Then, the device 100 is able to calculate a device state score that is an index value which makes it possible to evaluate the state (or quality) of the own device on the basis of these pieces of information. In addition, the device 100 is also able to calculate, together, a reliability score that is an index value indicating the reliability of the device state score (or the reliability itself). The methods of calculating the device state score and the reliability score are described below. Note that the sensors and event used to calculate the device state score and the reliability score are not particularly limited. In addition, the device that calculates the device state score and the reliability score may be the device 100 itself to be evaluated, the other device 100, or an external device (e.g., cloud server, etc.).

In addition, the device 100 is able to calculate an index value (referred to as “user article use score” below, which is also regarded as a value indicating the appropriateness of the use of the device 100 by a user) indicating how properly (or carefully) a user is able to use the device 100, on the basis of the use situation or the like of each device 100 by the user. More specifically, the device 100 is able to calculate the user article use score by comprehensively considering the device state score, the reliability score, the evaluation from the external system, and the like. The method of calculating the user article use score is described below.

As described above, the state of the device 100 is evaluated on the basis of the device state score and the reliability score, and the user is evaluated on the basis of the user article use score, thereby making it possible, for example, to more properly display the state of the device 100 and set a price. In addition, for example, it is possible to lend the devices 100 in different states to respective users. The details thereof are described below.

In addition, in the sharing economy service or the like, the device 100 is able to detect that a borrower and an actual user are different from each other. More specifically, as described above, the device 100 is able to perform user authentication on the basis of various sensors. Accordingly, authenticating the user of the device 100 makes it possible to determine whether or not the borrower and the actual user are different from each other. As a result, in a case where the borrower and the actual user are different from each other, it is possible, for example, to stop the use of the device 100, and reset the rental price in accordance with the user article use score or the like of the user.

In addition, the present disclosure provides various UI regarding the device 100. For example, there is provided UI used to manage the device 100, UI used to recommend the device 100 that should be carried, UI used to issue a notification of an object left behind, UI that indicates the situation of user authentication, UI that displays the selling price or the like of the device 100, UI that allows a user to confirm the user article use score or the like of the user himself or herself, or the like. The details of each UI are described below.

### 3. FUNCTIONAL COMPONENT OF DEVICE

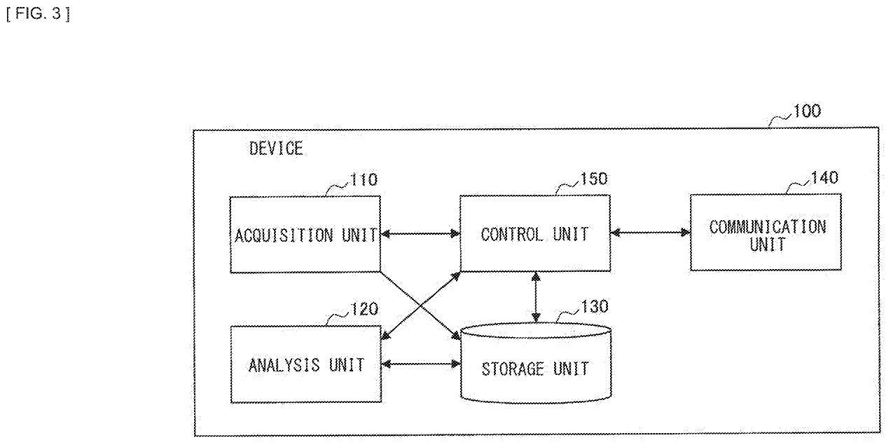

The overview of the present disclosure has been described above. Next, referring to FIG. 3, the functional component of the device 100 is described. Note that the functions of the respective functional components described below are merely examples, but are not particularly limited.

As illustrated in FIG. 3, the device 100 includes an acquisition unit 110, an analysis unit 120, a storage unit 130, a communication unit 140, and a control unit 150.

### Acquisition Unit 110

The acquisition unit 110 acquires sensing data from various sensors included in the device 100. The acquisition unit 110 stores the acquired sensing data in the storage unit 130.

### Analysis Unit 120

The analysis unit 120 achieves various kinds of processing by analyzing sensing data acquired by the acquisition unit 110. For example, the analysis unit 120 functions as an authentication unit that authenticates a user carrying the device 100. In addition, the analysis unit 120 also functions as a relevance recognition unit that recognizes the relevance between two or more users who share the device 100. In addition, the analysis unit 120 also functions as an action prediction unit that performs action prediction for a user carrying the device 100. In addition, the analysis unit 120 also functions as a category recognition unit that recognizes a category of the device 100. In addition, the analysis unit 120 also functions as a device state calculation unit that calculates a value (device state score) indicating the state or quality of the device 100, on the basis of an event or the like that has happened to the device 100 in the past. Further, the analysis unit 120 also functions as a user appropriateness calculation unit that calculates a value (user article use score) indicating the appropriateness of the use of the device 100 by a user, on the basis of the device state score and reliability score of the device 100 used by the user in the past. The function of the analysis unit 120 is described in detail below.

### Storage Unit 130

The storage unit 130 stores various kinds of information. For example, the storage unit 130 stores sensing data acquired by the acquisition unit 110, various kinds of information used for the processing of the analysis unit 120 or the control unit 150, a processing result of the analysis unit 120 or the control unit 150, and the like. In addition, the storage unit 130 may also store a program, a parameter, or the like used by each functional component of the device 100.

### Communication Unit 140

The communication unit 140 communicates with another device. For example, the communication unit 140 transmits sensing data acquired by the acquisition unit 110, processing data generated by the analysis unit 120 or the control unit 150, and the like to the other device 100 through wireless communication. In addition, the communication unit 140 may receive data similar to the above from the other device 100.

### Control Unit 150

The control unit 150 integrally controls the processing of each functional component described above. In addition, the control unit 150 controls various kinds of processing on the basis of an analysis result of the analysis unit 120. For example, the control unit 150 functions as a recommendation unit that outputs the device 100 recommended to be carried, and notifies a user of an object left behind, an unnecessary object, and the like. In addition, the control unit 150 also functions as a registration unit that registers the owner of the device 100 on the basis of the carried state of the device 100. In addition, the control unit 150 controls the cooperation (such as sharing of carried-history information) with the other device 100 on the basis of a category of the device 100. In addition, in a case where the device 100 is carried by a third person, the control unit 150 notifies the owner of that. In addition, the control unit 150 controls the display of information regarding the current or past carried state of the device 100. Further, the control unit 150 controls the processing of the own device or another device on the basis of a result of user authentication (such as unlocking a door, a smartphone, or the like, for example). The function of the control unit 150 is described in detail below.

### 4. OPERATION OF DEVICE

The functional components of the device 100 have been described above. Next, the operation of the device 100 is described.

### 4-1. Carrying Recognition

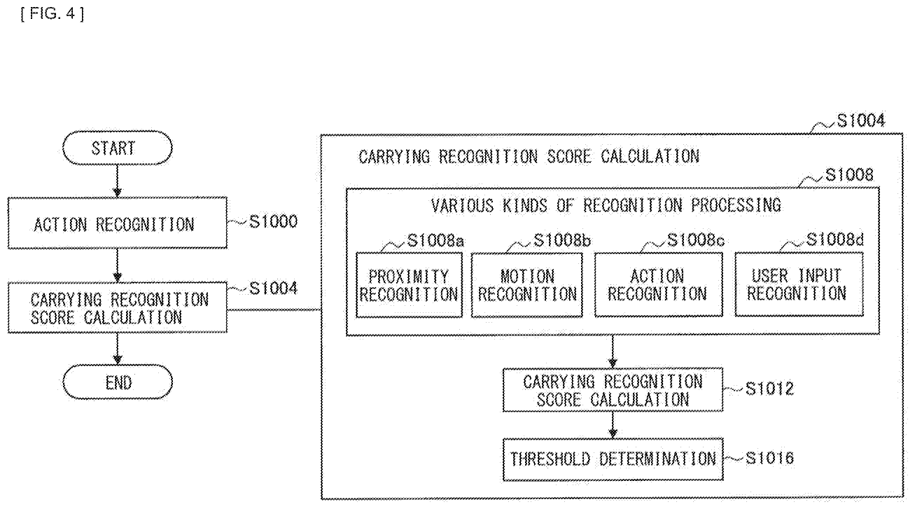

First, referring to FIG. 4, an operation (referred to as “carrying recognition”) of determining whether or not a user is carrying the device 100 is described.

In step S1000, the analysis unit 120 perform action recognition for a user on the basis of sensing data. More specifically, the analysis unit 120 extracts the feature amount of sensing data, and inputs the feature amount to an action model generated in advance by machine learning or the like. Then, the analysis unit 120 recognizes an action of the user by comparing the feature amount of each action in the action model with the inputted feature amount. This processing is merely an example, but the action recognition processing is not limited thereto.

In step S1004, the analysis unit 120 calculates a carrying recognition score on the basis of a result of the action recognition and other various kinds of information. The “carrying recognition score” is an index value indicating whether or not the certain device 100 is carried by a user.

In step S1008, the analysis unit 120 performs various kinds of recognition processing such as proximity recognition (S1008a), motion recognition (S1008b), action recognition (S1008c), and user input recognition (S1008d) (a result of the processing in step S1000 may be used for the action recognition). Note that these kinds of processing are merely examples, but processing to be performed is not limited to thereto.

The “proximity recognize (S1008a)” refers to processing of calculating, in the presence of the device 100 known to be carried by a user in addition to the device 100 to be recognized, the separation distance between the carried device 100 and the device 100 to be recognized. If the carried device and the device 100 to be recognized are positioned within the range of a predetermined distance or less, the device 100 to be recognized is also highly likely to be carried together.

The “motion recognition (S1008b)” refers to processing of detecting the motion of the device 100 to be recognized, for example, on the basis of an acceleration sensor of the device 100. As the certainty factor of the motion recognition by the device 100 to be recognized is higher, the device 100 is more likely to be carried by a user. Note that a sensor other than the acceleration sensor may be used.

The contents of the “action recognition (S1008c)” have been described above. As the certainty factor of the action recognition by the device 100 to be recognized is higher, the device 100 is more likely to be carried by a user.

The “user input recognition (S1008d)” refers to processing of recognizing whether or not the device 100 is carried, which is inputted by a user operation. In a case where a user explicitly makes an input indicating that the user is carrying the device 100, the device 100 is highly likely to be carried by the user. Note that the user input recognition may be performed on the basis of any input that makes it possible to infer that a user is carrying the device 100 instead of an explicit input.

In step S1012, the analysis unit 120 calculates a carrying recognition score by summing the values obtained by weighting, with weighting factors, the respective results (certainty factors) of the proximity recognition, the motion recognition, the action recognition, and the user input recognition as in Expression 1.

[Expression 1]

CARRYING RECOGNITION SCORE=Wₐ·a+W_{b}·b+W_{c}·c+W_{d}·d (EXPRESSION 1)
a: CERTAINTY FACTOR OF PROXIMITY RECOGNITION
b: CERTAINTY FACTOR OF MOTION RECOGNITION
c: CERTAINTY FACTOR OF ACTION RECOGNITION
d: CERTAINTY FACTOR OF USER INPUT RECOGNITION
Wₐ TO W_{d}: WEIGHING FACTORS

In step S1016, the analysis unit 120 compares the calculated carrying recognition score with a predetermined threshold. The analysis unit 120 then determines that the device 100 is carried by a user if the carrying recognition score is higher than the predetermined threshold, and determines that the device 100 is not carried by a user if the carrying recognition score is lower than or equal to the predetermined threshold.

The operation described above allows the analysis unit 120 to more accurately recognize whether or not a user is carrying the device 100. Note that the operation described above is merely an example, and may be changed as appropriate. For example, the various kinds of recognition processing in step S1008 may be performed in parallel, or may be performed stepwise or partially omitted in accordance with the required accuracy or the like.

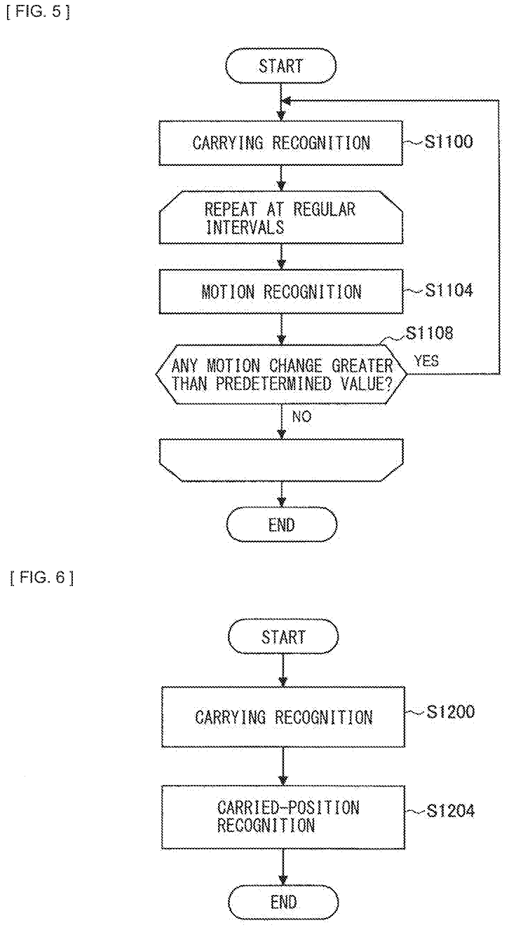

In addition, as illustrated in FIG. 5, the analysis unit 120 may reduce power consumption by combining processing with a lighter load than the load of the carrying recognition with the carrying recognition.

For example, after carrying recognition is performed in step S1100 and it is recognized that the device 100 is carried, the analysis unit 120 may repeat motion recognition with an acceleration sensor or the like in step S1104 at regular intervals. The motion recognition is processing with a lighter load than the load of the carrying recognition. Then, in a case where no motion change greater than the predetermined value is detected (i.e., in a case where a user continues similar operations) (step S1108/No), the analysis unit 120 continues to repeat the motion recognition at regular intervals. In contrast, in a case where a motion change greater than the predetermined value is detected (step S1108/Yes), the processing returns to step S1100, and the analysis unit 120 performs carrying recognition.

The operation described above allows the analysis unit 120 to reduce power consumption. In other words, the analysis unit 120 does not continue at all times the carrying recognition that consumes much power, but recognizes that the carried state does not have a great change in a case where the motion of a user does not have a great change. The analysis unit 120 performs the motion recognition with a lighter load, thereby allowing for a reduction in power consumption while maintain the high accuracy of recognizing whether or not the device 100 is carried. Note that the operation described above is merely an example, and may be changed as appropriate.

### 4-2. Carried-Position Recognition

Next, referring to FIG. 6, an operation (referred to as “carried-position recognition” below) of determining a position (e.g., worn on a portion of a body (such as a face, an ear, a neck, a hand, an arm, a waist, or a foot), or put in a pocket (such as a chest pocket, or a front or back pocket) or a bag (such as a shoulder bag, a backpack, or a tote bag)) at which the device 100 is described.

In the step S1200, the carrying recognition illustrated in FIG. 4 or 5 is performed. In a case where it is recognized that the device 100 is carried by a user, the analysis unit 120 performs the carried-position recognition on the basis of sensing data in step S1204. For example, the analysis unit 120 extracts the feature amount of sensing data from an acceleration sensor or a gyro sensor, and inputs the feature amount to a carried-position model generated in advance by machine learning or the like. Then, the analysis unit 120 recognizes the carried position of the device 100 by comparing the feature amount of each carried position in the carried-position model with the inputted feature amount. This is merely an example, but the method of recognizing a carried-position is not limited to thereto.

For example, with respect to the device 100 having a known category, the analysis unit 120 may perform the carried-position recognition after omitting the carried-position recognition described above, selecting a candidate for a carried position, or excluding an impossible carried position. More specifically, if the device 100 has the category “shoes”, the analysis unit 120 may omit the carried-position recognition by setting “foot (worn on foot)” as the carried position. In addition, if the device 100 has the category “umbrella”, the analysis unit 120 may perform the carried-position recognition after selecting “hand (grasped)”, “arm (hung from arm)”, “bag (put in bag)”, or the like as a candidate for a carried position, or excluding “foot (worn foot)”, “head (worn on head)”, or the like, which is impossible as the carried position of an umbrella. In addition, the analysis unit 120 may omit the carried-position recognition if a user inputs the carried position of the device 100 by using an input unit (not illustrated). These allow the analysis unit 120 to reduce more power consumption and further improve the processing speed.

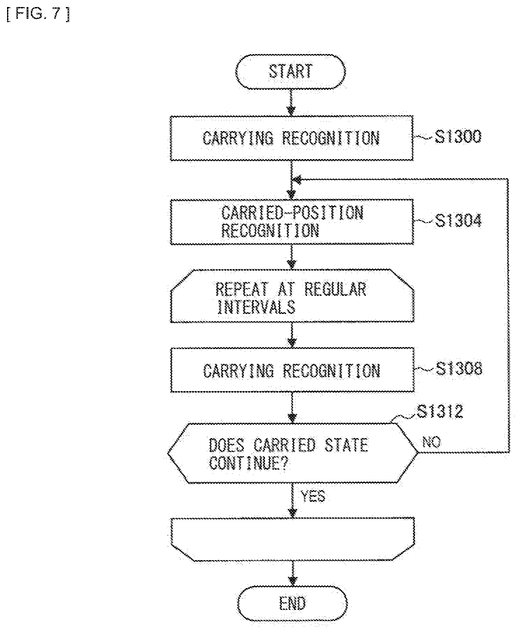

In addition, as illustrated in FIG. 7, the analysis unit 120 may reduce power consumption by combining processing with a lighter load than the load of the carried-position recognition with the carried-position recognition.

For example, it is assumed that carrying recognition is performed in step S1300, it is recognized that the device 100 is carried, carried-position recognition is performed in step S1304, and the position at which the device 100 is carried is recognized. Thereafter, the analysis unit 120 may repeat the carrying recognition at regular intervals in step S1308. The carrying recognition is processing with a lighter load than the load of the carried-position recognition. Then, in a case where the state in which the device 100 is carried continues (step S1312/Yes), the analysis unit 120 continues to repeat the carrying recognition at regular intervals. In contrast, in a case where the state in which the device 100 is carried does not continue (step S1312/No), the processing returns to step S1304, and the analysis unit 120 performs the carried-position recognition again.

The operation described above allows the analysis unit 120 to reduce power consumption. In other words, the analysis unit 120 does not continue at all times the carried-position recognition that consumes much power, but recognizes that the carried-position does not change in a case where the carried state continues. The analysis unit 120 performs the carrying recognition with a lighter load, thereby allowing for a reduction in power consumption while maintaining the high accuracy of recognizing the carried position. For example, the processing described above is effective especially for the device 100 that is carried (worn) at a limited position such as shoes and a wristwatch, and is less likely to change the position once carried. In addition, in a case where the device 100 is shoes, a wristwatch, or the like on the basis of a category or the like, the analysis unit 120 may omit the carried-position recognition as appropriate or change the carried-position recognition to processing with a lighter load. Note that the operation described above is merely an example, and may be changed as appropriate.

### 4-3. Same-Person Carrying Recognition

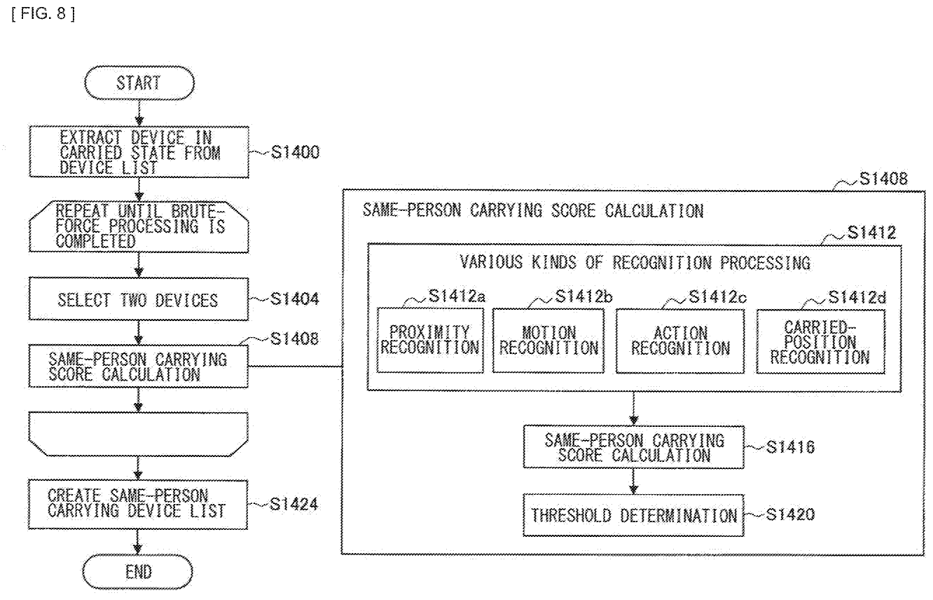

Next, referring to FIG. 8, an operation of determining the device 100 carried by the same person (referred to as “same-person carrying recognition” below) is described. This operation allows each device 100 to recognize, in a case where two or more users are positioned close to each other (within the range of a predetermined distance or less), a group of the carried devices 100 for each user. This makes it possible to perform an operation of authenticating a user, which is described below.

First, although not illustrated, the carrying recognition illustrated in FIG. 4 or 5 is performed before the same-person carrying recognition is performed. Note that the carried-position recognition illustrated in FIG. 6 or FIG. 7 may be performed together. Then, in a case where it is recognized through the carrying recognition that the device 100 is carried by a user, the analysis unit 120 extracts the device 100 in the carried state from a device list in step S1400.

In step S1404, the analysis unit 120 then selects two of the devices 100 in the carried state. In step S1408, the analysis unit 120 calculates a same-person carrying score. The “same-person carrying score” is an index value used to determine whether or not the two devices 100 are carried by the same person.

In step S1412, the analysis unit 120 performs various kinds of recognition processing such as proximity recognition (S1412a), motion recognition (S1412b), action recognition (S1412c), and carried-position recognition (S1412d) (a result of the processing performed in the preceding step may be used for the various recognition processing). Note that the contents of the various kinds of recognition processing have been described above. In addition, these kinds of processing are merely examples, but processing to be performed is not limited to thereto.

The “proximity recognition (S1412a)” causes the separation distance between the two devices 100 to be calculated. As the distance between the two devices 100 is shorter, the respective devices 100 are more likely to be carried by the same user.

The “motion recognition (S1412b)” causes the motion of the device 100 to be detected. As the correlation value of the two devices 100 is higher, the respective devices 100 are more likely to be carried by the same user.

The “action recognition (S1412c)” causes an action of a user to be recognized. As the correlation value of the actions of users that are recognized by the two devices 100 is higher, the respective devices 100 are more likely to be carried by the same user.

The “carried-position recognition (S1412d)” causes the carried position of the device 100 to be recognized. In a case where the motions of the two devices 100 are correlated with each other in a case where the carried-positions of the respective devices 100 are the same or similar, the respective devices 100 are highly likely to be carried by the same user.

In step S1416, the analysis unit 120 calculates a same-person carrying score by summing the values obtained by weighting, with weighting factors, the respective results (certainty factors) of the proximity recognition, the motion recognition, the action recognition, and the carried-position recognition as in Expression 2.

[Expression 2]

SAME-PERSON CARRYING SCORE=Wₐ·a+W_{b}·b+W_{c}·c+W_{d}·d (EXPRESSION 2)
a: CERTAINTY FACTOR OF PROXIMITY RECOGNITION
b: CERTAINTY FACTOR OF MOTION RECOGNITION
c: CERTAINTY FACTOR OF ACTION RECOGNITION
d: CERTAINTY FACTOR OF CARRIED-POSITION RECOGNITION
Wₐ TO W_{d}: WEIGHTING FACTORS

In step S1420, the analysis unit 120 compares the calculated same-person carrying score with a predetermined threshold. The analysis unit 120 then determines that the two devices 100 are carried by the same person if the same-person carrying score is higher than the predetermined threshold, and determines that the two devices 100 are not carried by the same person if the same-person carrying score is lower than or equal to the predetermined threshold. The analysis unit 120 repeats calculating same-person carrying scores and comparing them with a predetermined threshold for the devices 100 in the carried states in a brute-force manner. As a result of the processing, in step S1424, the analysis unit 120 creates a list (illustrated as “same-person carrying device list” in the diagram) of the devices 100 carried by the same person.

The operation described above allows the analysis unit 120 to more accurately recognize the devices 100 carried by the same person. Note that the operation described above is merely an example, and may be changed as appropriate. For example, the various kinds of recognition processing in step S1412 may be performed in parallel, or may be performed stepwise or partially omitted in accordance with the required accuracy or the like.

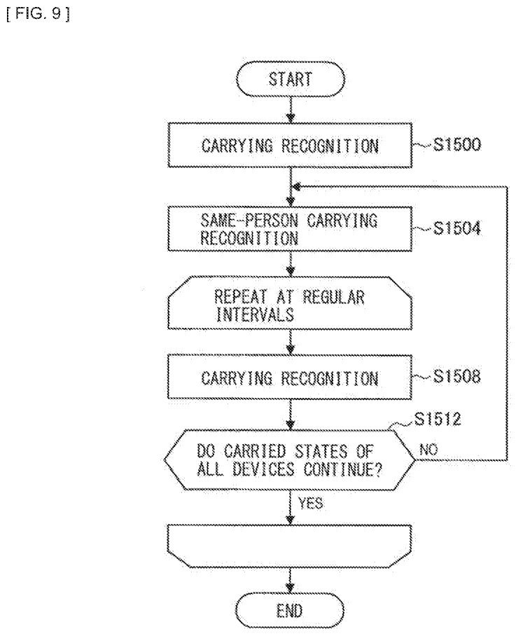

In addition, as illustrated in FIG. 9, the analysis unit 120 may reduce power consumption by combining processing with a lighter load than the load of the same-person carrying recognition with the same-person carrying recognition.

For example, it is assumed that carrying recognition is performed in step S1500, it is recognized that the devices 100 are carried, same-person carrying recognition is performed in step S1504, and the devices 100 carried by the same person are recognized. Note that, as described above, the carried-position recognition may be performed together. Thereafter, the analysis unit 120 may repeat the carrying recognition at regular intervals in step S1508. The carrying recognition is processing with a lighter load than the load of the same-person carrying recognition. Then, in a case where the states of all the devices 100 that are recognized as being carried by the same person continue (step S1512/Yes), the analysis unit 120 continues to repeat the carrying recognition at regular intervals. In contrast, in a case where the carried state of any of the devices 100 changes (step S1512/No), the processing returns to step S1504, and the analysis unit 120 performs the same-person carrying recognition again.

The operation described above allows the analysis unit 120 to reduce power consumption. In other words, the analysis unit 120 does not continue at all times the same-person carrying recognition that consumes much power, but recognizes that the respective devices 100 are continuously carried by the same person in a case where the carried states continue. The analysis unit 120 performs the carrying recognition with a lighter load, thereby allowing for a reduction in power consumption while maintaining the high accuracy of the same-person carrying recognition. Note that the operation described above is merely an example, and may be changed as appropriate.

### 4-4. Carrying-Person Recognition (User Authentication)

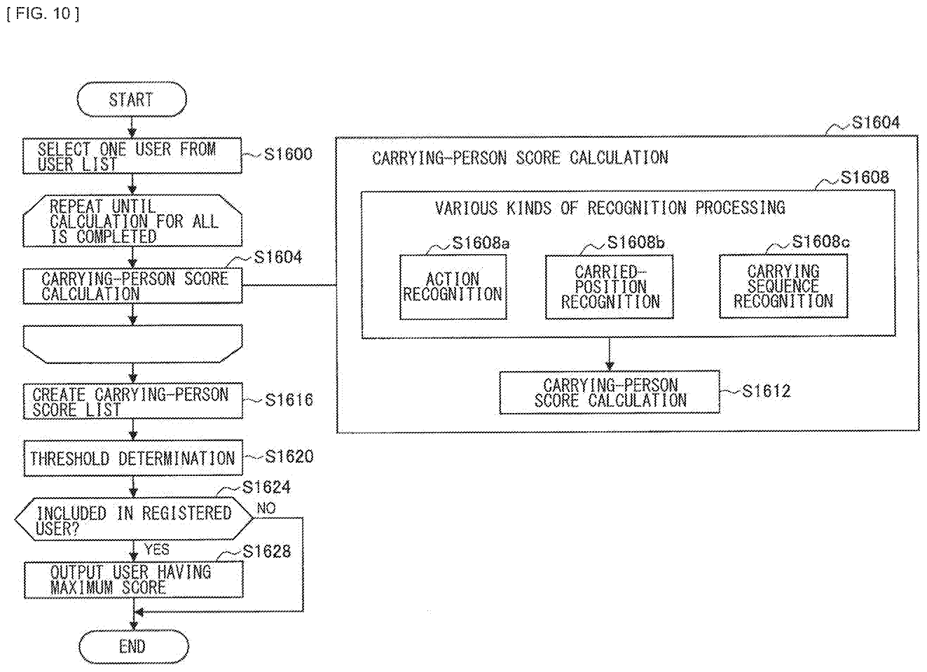

Next, referring to FIG. 10, an operation for determining a user carrying the device 100 (referred to as “carrying-person recognition” below, which is equivalent to user authentication) is described.

First, although not illustrated, it is assumed that the carrying recognition, the carried-position recognition, and the same-person carrying recognition are performed before the carrying-person recognition is performed, but this is not limitative.

In step S1600, the analysis unit 120 then selects one person from a user list indicating candidates for the user carrying the device 100, and calculates a carrying-person score in step S1604. The “carrying-person score” is an index value indicating the similarity between the one person selected from the list and a user to be subjected to the carrying-person recognition.

In step S1608, the analysis unit 120 performs various kinds of recognition processing such as action recognition (S1608a), carried-position recognition (S1608b), and carrying sequence recognition (S1608c) (a result of the processing performed in the preceding step may be used for the action recognition or the carried-position recognition). In addition, these kinds of processing are merely examples, but processing to be performed is not limited to thereto.

The “action recognition (S1608a)” causes an action of a user including the carried state of the device 100 to be recognized. As actions of the user selected from the user list and the user to be authenticated have a higher correlation value, the respective users are more likely to be the same person.

The “carried-position recognition (S1608b)” causes the carried position of the device 100 to be recognized. As the carried positions of the devices 100 has a higher correlation value for the respective users, the respective users are more likely to be the same person.

The “carrying sequence recognition (S1608c)” refers to processing of recognizing the timing at which the plurality of devices 100 is carried by users. For example, as a higher correlation value is exhibited for the order in which the respective users carry the respective devices 100 (e.g., which device 100 is carried first, or which devices 100 are simultaneously carried), the time elapsed from the certain device 100 being carried to the other device 100 being carried, or the like, the respective users are more likely to be the same.

In step S1612, the analysis unit 120 calculates a carrying-person score by summing the values obtained by weighting, with weighting factors, the respective results (certainty factors) of the action recognition, the carried-position recognition, and the carrying sequence recognition as in Expression 3. In addition, the analysis unit 120 repeats the processing until completing calculating carrying-person scores for all the members in the user list.

[Expression 3]

CARRYING-PERSON SCORE=Wₐ·a+W_{b}·b+W_{c}·c (EXPRESSION 3)
a: CERTAINTY FACTOR OF ACTION RECOGNITION
b: CERTAINTY FACTOR OF CARRIED-POSITION RECOGNITION
c: CERTAINTY FACTOR OF CARRYING SEQUENCE RECOGNITION
Wₐ TO W_{c}: WEIGHTING FACTORS

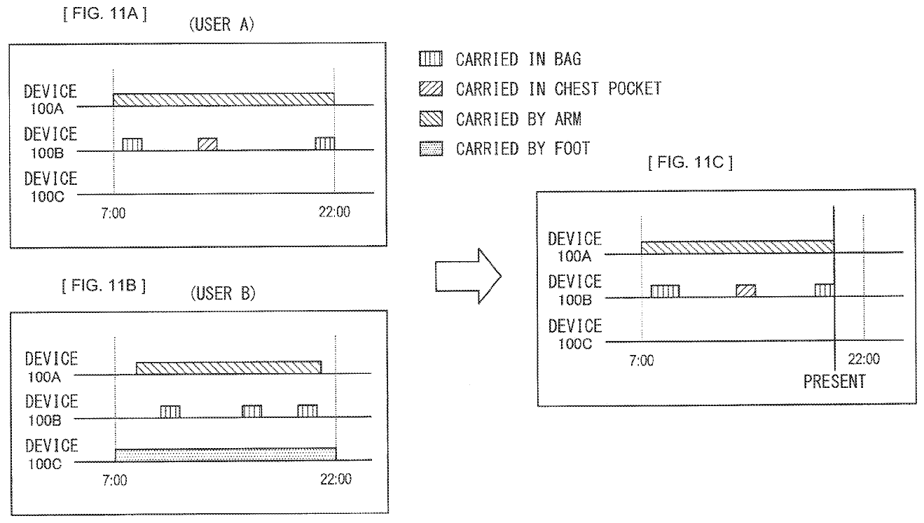

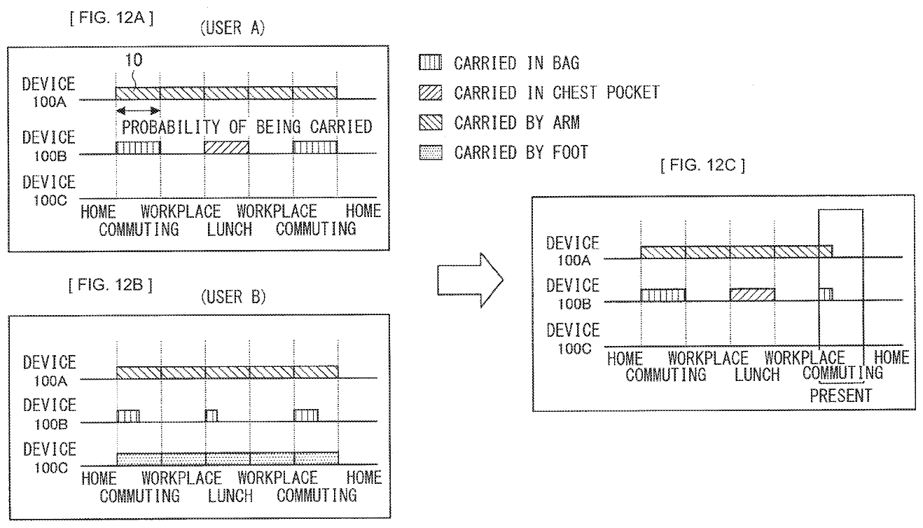

Referring to FIGS. 11 and 12, an image of the carrying-person score calculation is now described. FIG. 11 illustrates, in 11A and 11B, in chronological order, pieces of carried-history information of devices 100A to 100C by a user A and a user B included in a portion of users selected from a user list. The analysis unit 120 then calculates carrying-person scores indicating the similarity between a user to be authenticated illustrated in 11C, and the user A and the user B selected from the user list.

As a result of the action recognition, the analysis unit 120 recognizes, for example, which device 100 is carried in each time slot and what action is performed in each time slot. As a result of the carried-position recognition, the analysis unit 120 recognizes, for example, where the carried-position of the device 100 is. As a result of the carrying sequence recognition, the analysis unit 120 recognizes, for example, in what order the respective devices 100 are carried. On the basis of these elements, the analysis unit 120 then calculates carrying-person scores indicating the similarity between the user to be authenticated, and the user A and the user B. For example, 11A is more similar to 11C than 11B, and the analysis unit 120 thus outputs a higher carrying-person score for the user A than that of the user B.

In addition, the analysis unit 120 may use carried-history information indicating the carried states of the respective devices 100 for each action sequence as in FIG. 12, instead of FIG. 11 illustrating the carried states of the respective devices 100 in chronological order. The “action sequence” is information regarding the order of actions performed by a user. For example, as illustrated in FIG. 12, the carried-history information indicates the typical order of actions of each user and the carried state of each device 100 at the time of each action. Note that the length of each bar 10 indicates the probability that the device 100 is carried at the illustrated carried position at the time of each action. The device 100 is able to compress the data capacity by storing the carried-history information for each action sequence as compared to the data capacity in a case where storing the carried-history information in chronological order.

The analysis unit 120 may calculate a carrying-person score by using either of the methods of FIGS. 11 and 12. Note that carried-history information in any period may be compared. For example, the analysis unit 120 may calculate a carrying-person score on the basis of carried-history information starting at the time point when a user starts activity of the day. In addition, the analysis unit 120 may calculate a carrying-person score on the basis of the carried state of the device 100 at a certain time point. For example, the analysis unit 120 may calculate a carrying-person score the basis of the carried state of the device 100 at certain time or at a time point when a user performs a certain action. Thus, the device 100 that is a house key calculates a carrying-person score and enables user authentication, for example, immediately before a user comes home, thereby allowing the user to enter the house by using the key, and the like.

In addition, the analysis unit 120 may calculate a carrying-person score by using even information indicating that the device 100 is not carried. For example, the analysis unit 120 may calculate a carrying-person score on the basis of information indicating that the device 100A is carried in a certain time slot and the device 100B is not carried in the certain time slot. In addition, the analysis unit 120 may calculate a carrying-person score by using even information of the place in which the device 100 is positioned.

Then, in the step S1616 of FIG. 10, the analysis unit 120 creates a carrying-person score list. The “carrying-person score list” is a list indicating a carrying-person score for each user. In step S1620, the analysis unit 120 compares each score of the carrying-person score list with a predetermined threshold. The “predetermined threshold” is assumed to be a value set as a border value indicating whether or not each user and a user to be authenticated are likely to be the same person, but is not limited thereto. This allows the analysis unit 120 to eliminate a user who is not likely to be (or least unlikely to be) the same person as the user to be authenticated.

In a case where there is a user who is likely to be the same person as the user to be authenticated (step S1624/Yes), the analysis unit 120 outputs the user with the highest carrying-person score in step S1628. Note that, in a case where a plurality of carrying-person scores competes with each other, the analysis unit 120 may output the corresponding two or more users, or may output the carrying-person score list itself. In a case where none of the users in the user list seems the same person as the user to be authenticated (step S1624/No), the processing ends. Note that the analysis unit 120 may output information indicating that no one is the same as the user to be authenticated, or may output the contents of the carrying-person score.

The operation described above allows the analysis unit 120 to more accurately authenticate a user carrying the device 100. Note that the operation described above is merely an example, and may be changed as appropriate. For example, the various kinds of recognition processing in step S1608 may be performed in parallel, or may be performed stepwise or partially omitted in accordance with the required accuracy or the like.

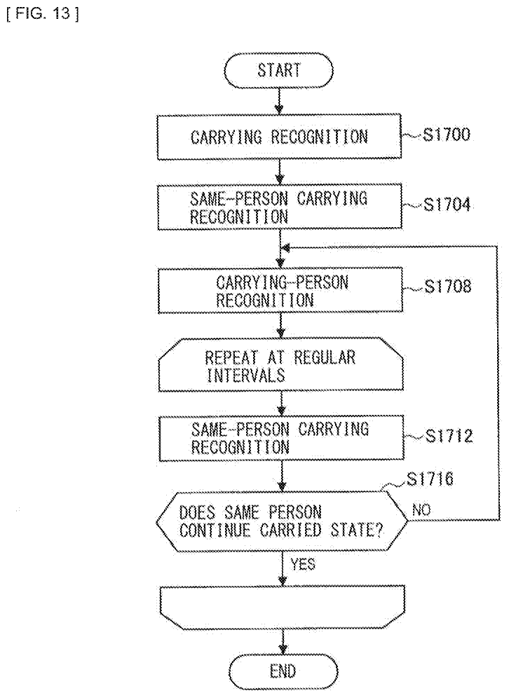

In addition, as illustrated in FIG. 13, the analysis unit 120 may ensure the identification of a user while reducing power consumption by combining processing with a lighter load than the load of the carrying-person recognition with the carrying-person recognition.

For example, carrying recognition is performed in step S1700, it is recognized that the devices 100 are carried, same-person carrying recognition is performed in step S1704, and the devices 100 carried by the same person are recognized. Note that the carried-position recognition may be performed together. Then, it is assumed that the carrying-person recognition is performed in step S1708 and a user carrying the device 100 is authenticated. Thereafter, the analysis unit 120 may repeat the carrying recognition at regular intervals in step S1712. The same-person carrying recognition is processing with a lighter load than the load of the carrying-person recognition. Then, in a case where the state in which the respective devices 100 are carried by the same person continues (step S1716/Yes), the analysis unit 120 continues to repeat the same-person carrying recognition at regular intervals. In contrast, in a case where the respective devices 100 are not carried by the same person (step S1716/No), the processing returns to step S1708, and the analysis unit 120 performs the carrying-person recognition again.

The operation described above allows the analysis unit 120 to reduce power consumption. In other words, the analysis unit 120 does not continue at all times the carrying-person recognition that consumes much power, but recognizes that a user carrying the respective devices 100 is not changed in a case where the carried states by the same person continue. The analysis unit 120 performs the same-person carrying recognition with a lighter load. This allows the analysis unit 120 to reduce power consumption while maintaining the high accuracy of authenticating the user carrying the device 100. Note that the operation described above is merely an example, and may be changed as appropriate.

### 4-5. Person Relevance Recognition

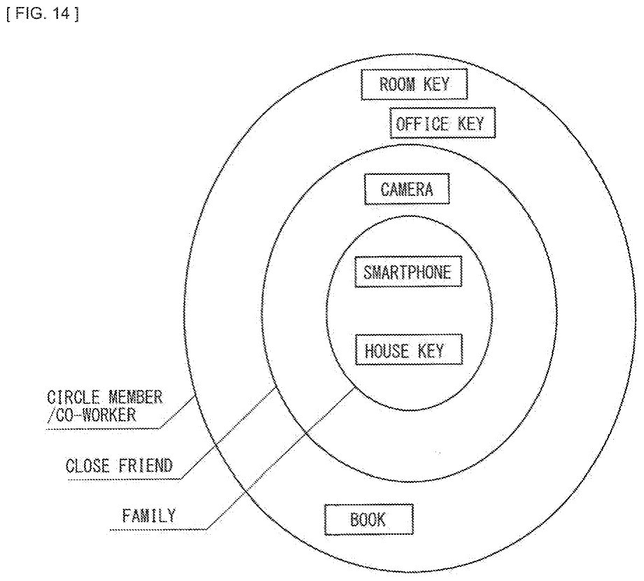

Next, referring to FIG. 14, the overview of an operation (referred to as “person relevance recognition” below) of determining the relevance between users sharing the devices 100 is described. As described above, in a case where two or more users share the devices 100, the relevance between the respective users may be recognized on the basis of the sharing situation of each device 100.

For example, the relevance between the respective users may be recognized in accordance with the importance of each device 100 shared among the users. More specifically, in a case where the device 100 of high importance such as a “smartphone” or a “house key” is shared between two or more users as illustrated in FIG. 14, the relevance between the respective users may be recognized as being high. Meanwhile, in a case where the device 100 of medium importance such as a “camera” is shared, the relevance between the respective users may also be recognized as being medium. In a case where the device 100 of low importance such as a “room key”, an “office key” or a “book” is shared, the relevance between the respective users may also be recognized as being low. Note that the importance of each device 100 is not limited to importance generally recognized. For example, a user may also be able to set the importance (or index value corresponding to the importance) of each device 100 by a predetermined method.

Note that the above demonstrates merely examples, but the methods of recognizing the relevance between the respective users are not limited thereto. For example, the relevance between the respective users may be recognized in accordance with the number of the devices 100 shared among the users. As the number of the devices 100 that are shared between users is larger, the relevance between the respective users may be recognized as being higher.

In a case where the relevance between the respective users is recognized, the device 100 is able to perform various kinds of control on the basis of this relevance. For example, in a case where the device 100 is a “camera”, it is possible to autonomously change viewable shot images, available operation contents, and the like between a user having high relevance to the owner and a user not having such relevance.

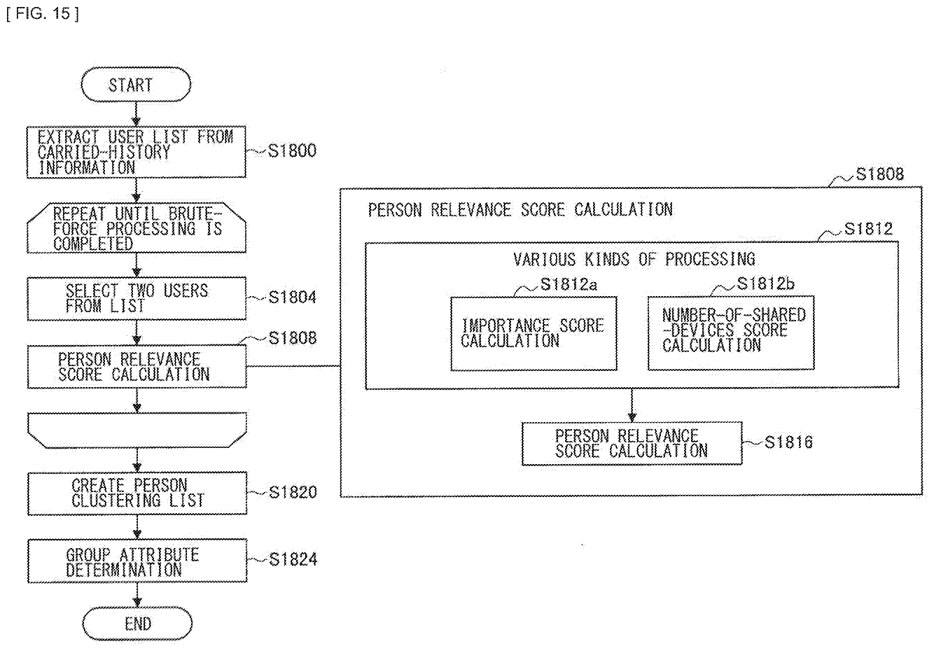

Next, referring to FIG. 15, a specific operation of the person relevance recognition is described. In step S1800, the analysis unit 120 extracts, from the carried-history information, a list of users who have used the device 100 in the past. In step S1804, the analysis unit 120 then selects two of the users who have used the device 100, and calculates a person relevance score in step S1808. The “person relevance score” is an index value used to determine the relevance of the two users.

In step S1812, the analysis unit 120 performs various kinds of processing such as importance score calculation (S1812a) and number-of-shared-devices score calculation (S1812b). In addition, these kinds of processing are merely examples, but processing to be performed is not limited to thereto.

The “importance score calculation (S1812a)” refers to processing of calculating an index value of the importance of each device 100. The device 100 calculates the importance score of each device 100 on the basis of a category, carried-history information, or the like of each device 100.

The “number-of-shared-devices score calculation (S1812b)” refers to processing of calculating an index value of the number of the devices 100 shared between two selected persons.

In step S1816, the analysis unit 120 calculates a person relevance score by summing the values obtained by weighting, with weighting factors, respective results of the importance score calculation and the number-of-shared-devices score calculation as in Expression 4. The analysis unit 120 repeats calculating person relevance scores for the users who have used the device 100 in a brute-force manner.

[Expression 4]

PERSON RELEVANCE SCORE=Wₐ·a+W_{b}·b (EXPRESSION 4)
a: IMPORTANCE DEGREE SCORE
b: NUMBER-OF-SHARED-DEVICES SCORE
Wₐ AND W_{b}: WEIGHTING FACTORS

In step S1820, the analysis unit 120 generates a person clustering list on the basis of the person relevance score. The “person clustering list” is a list indicating a combination of users having relevance and the degree (person relevance score) of the relevance. The “person clustering list” is information in which the respective users are divided into a plurality of groups.

In step S1824, attributes of groups to which the respective user belong are determined on the basis of the degree of the relevance. For example, the device 100 identifies the attributes (e.g., family, close friends, circle members, co-workers, etc.) of the respective groups by comparing the degree (person relevance score) of the relevance between the respective groups with a predetermined threshold.

The operation described above allows the analysis unit 120 to more accurately recognize the relevance between users sharing the device 100. Note that the operation described above is merely an example, and may be changed as appropriate. For example, the various kinds of processing in step S1812 may be performed in parallel, or may be performed stepwise or partially omitted in accordance with the required accuracy or the like.

### 4-6. Group Confirmation and Subsequent Operation

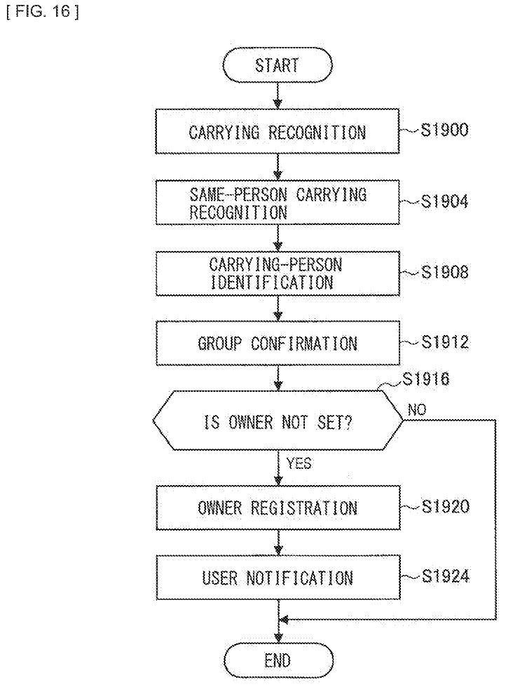

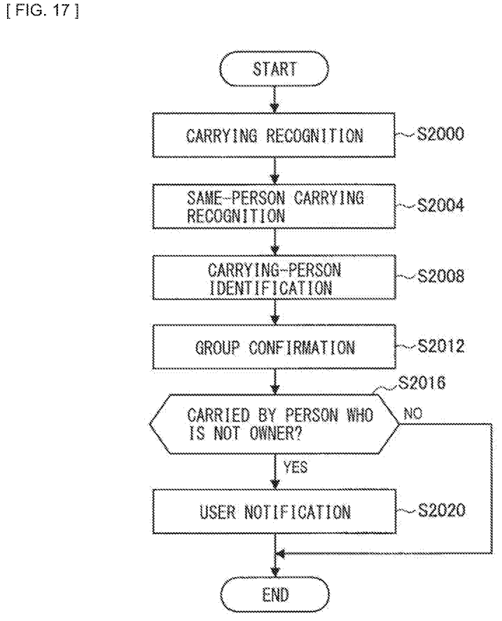

Next, referring to FIGS. 16 and 17, group confirmation by the device 100 and a subsequent operation are described. The “group confirmation” refers to processing of allowing the device 100 to confirm the owner of the own device or the group to which the own device belongs, by using the carrying-person recognition or person relevance recognition described above.

FIG. 16 illustrates an operation of allowing the device 100 for which no owner is set to perform group confirmation, and set an owner of the own device.

Carrying recognition is performed in step S1900, it is recognized that the devices 100 are carried, same-person carrying recognition is performed in step S1904, and the devices 100 carried by the same person are recognized. Note that the carried-position recognition may be performed together. Then, it is assumed that the carrying-person recognition is performed in step S1908 and a user carrying the device 100 is authenticated.

In step S1912, the control unit 150 confirms the group to which the own device belongs. For example, the control unit 150 confirms the owner of the own device. In a case where the owner of the own device is not set (step S1916/Yes), the control unit 150 registers the user carrying the own device as an owner in step S1920. In step S1924, the control unit 150 notifies the user that the owner is registered, by a predetermined method. In a case where an owner has already been set (step S1916/No), the processing ends.

The operation described above eliminates the necessity for a user to perform owner registration. Note that the operation described above is merely an example, and may be changed as appropriate. For example, before the user carrying the own device is registered as an owner in the step S1920, the control unit 150 may perform an operation of requesting the user to permit owner registration. This allows the control unit 150 to prevent owner registration not intended by the user.

Next, the operation in FIG. 17 is described. FIG. 17 illustrates an operation of, for example, notifying an owner in a case where the device 100 is carried by a user (or a user having low relevance to the owner) who is not the owner.

Steps S2000 to S2008 are the same as steps S1900 to S1908 in FIG. 16, and therefore descriptions thereof are omitted. In step S2012, the control unit 150 confirms the group to which the own device belongs. For example, the control unit 150 confirms the owner of the own device or the group to which the own device belongs. Then, in a case where it is determined that the own device is carried by a person who is not the owner or a person who does not belong to a group having high relevance (e.g., family, etc.) (step S2016/Yes), the control unit 150 notifies the owner of that by a predetermined method in step S2020. In a case where it is determined that the own device is carried by the owner or a person who belongs to a group having high relevance (step S2016/No), the processing ends.

The operation described above may prevent the device 100 from being, for example, stolen or lost. Note that the operation described above is merely an example, and may be changed as appropriate. For example, even in a case where it is determined in step S2016 that the own device is carried by a person or the like who belongs to a group having high relevance (step S2016/No), the control unit 150 may notify the owner of that by a predetermined method. In addition, in a case where it is determined that the own device is carried by a person or the like who is not the owner (step S2016/Yes), the control unit 150 may restrict the use of a portion of the functions of the own device, perform intensive monitoring, or ask the current owner whether or not to change the owner of the own device to the person (transfer the device 100) or whether or not to lend the own device to the person. Alternatively, instead of the carried device 100 itself, the processing described above may be achieved by the other device 100 present around the device 100.

### 4-7. Action Prediction and Carrying Recommendation

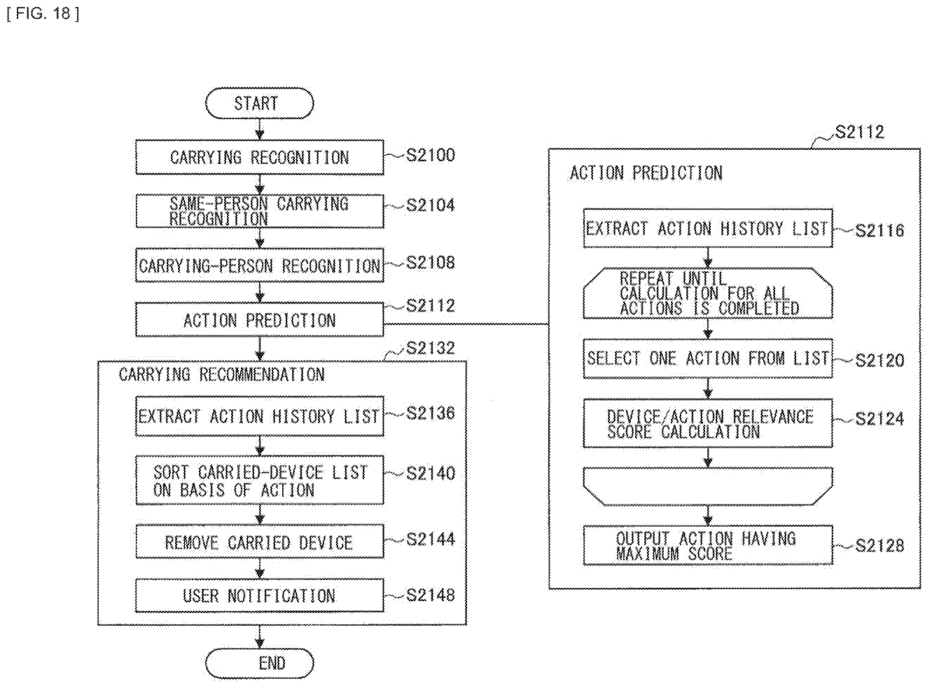

Next, referring to FIG. 18, operations of performing action prediction for a user on the basis of the carried state of the device 100 and recommending the device 100 that is carried (referred to as “carrying recommendation” below) are described. As described above, for example, the device 100 is able to predict an action of a user on the basis a combination or the like of the devices 100 carried by the user. The device 100 then calculates, on the basis of the action prediction result, the recommendation device 100 that seems desirable for the user to carry, and compares the recommendation device 100 with the device 100 that is actually carried. This makes it possible to notify the user of an excess or deficiency of the devices 100 (e.g., objects left behind, unnecessary objects, etc.).

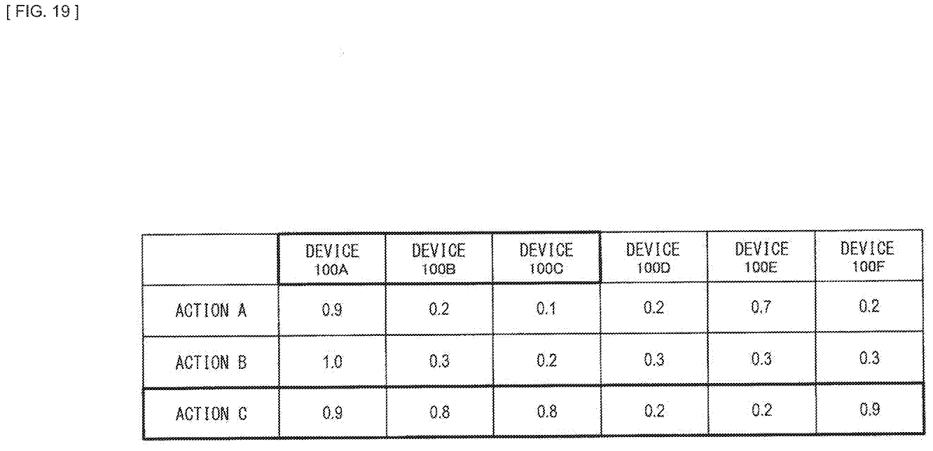

Steps S2100 to S2108 are the same as steps S1900 to S1908 in FIG. 16, and therefore descriptions thereof are omitted. In step S2112, the analysis unit 120 performs action prediction. More specifically, in step S2116, the analysis unit 120 extracts an action history list. Here, the “action history list” is information in which an action and the carried state of the device 100 at the time of each action (FIG. 19 illustrates, as an example, a value regarding the probability that the device 100 is carried at the time of each action) are associated with each other as illustrated in FIG. 19. Note that FIG. 19 illustrates merely an example, but the contents of the action history list are not limited to thereto.

The analysis unit 120 selects one action from the action history list in step S2120, and calculates a device/action relevance score in step S2124. The “device/action relevance score” is an index value indicating the relevance between the carried state of the device 100 and the selected action. For example, in a case where a user carries the devices 100A to 100C in FIG. 19, the device/action relevance scores are calculated on the basis of the values corresponding to the devices 100A to 100C for the respective actions in the action history list (e.g., the total value or average value of the values corresponding to the devices 100A to 100C, etc.).

The analysis unit 120 calculates device/action relevance scores for all actions. In step S2128, the analysis unit 120 outputs the action having the highest device/action relevance score. In the example of FIG. 19, an action C for which the values corresponding to the devices 100A to 100C carried by the user are the highest is outputted (i.e., the user is predicted to perform the action C). The operation described above allows the analysis unit 120 to more accurately predict an action of a user on the basis of the carried state of the device 100.

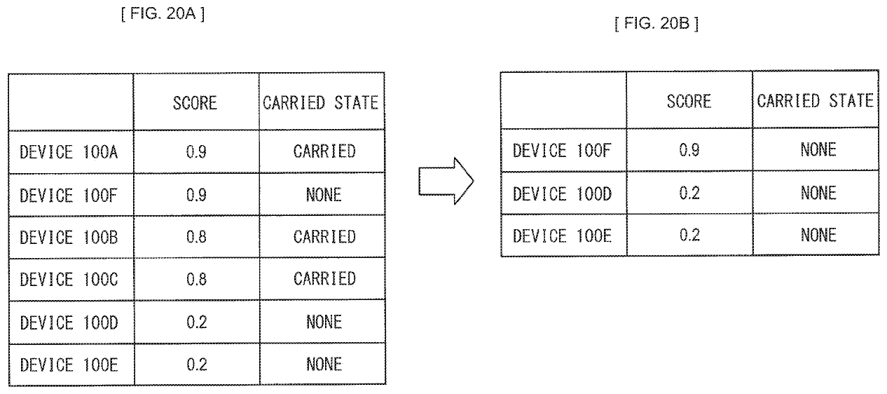

Then, in step S2132, the operation of carrying recommendation is performed on the basis of a result of the action prediction. First, the control unit 150 extracts an action history list in step S2136, and sorts a carried-device list on the basis of an action in step S2140. The “carried-device list” is information in which the respective devices 100, scores (probability of being carried), and carried states are associated with each other as illustrated in 20A of FIG. 20. The control unit 150 sorts the carried-device list in descending order of scores for the action C outputted by the action prediction, as illustrated in 20A.

In step S2144, the control unit 150 outputs a list of objects left behind by removing the carried device 100 from the carried-device list as illustrated in 20B (or the control unit 150 may output a list of objects left behind and unnecessary objects by extracting the difference between the carried-device list and the carried device 100). In step S2148, the control unit 150 notifies a user of an output result by a predetermined method.

The operation described above allows the device 100 to more accurately recognize an excess or deficiency of the devices 100 (e.g., objects left behind, unnecessary objects, etc.) and notify a user. Note that the operation described above is merely an example, and may be changed as appropriate. For example, in a case where an action of a user is known, the action prediction in step S2112 may be omitted as appropriate. In addition, the device 100 may change the accuracy and contents of processing for each device 100 by learning a user's tendency of objects left behind or unnecessary objects. In addition, the device 100 may change the accuracy and contents of processing between a period in which the device 100 is used and a period in which the device 100 is not used in a case where the device 100 is used in a limited period (e.g., ski products, skating products, or the like used only in winter).

### 4-8. Evaluation of State of Device 100

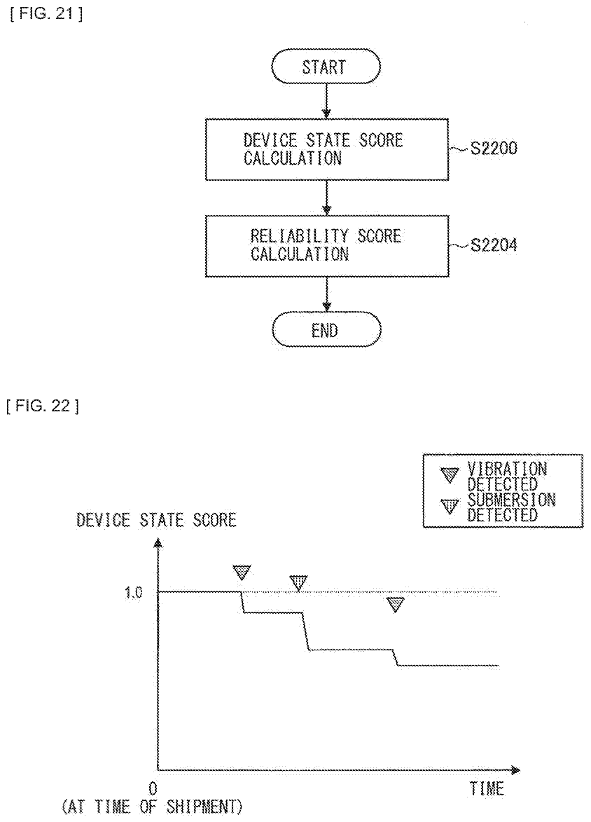

Next, referring to FIG. 21, an operation regarding the evaluation of the state of the device 100 is described.

First, in step S2200, the device 100 calculates a device state score. More specifically, the analysis unit 120 calculates a device state score by summing the values obtained by weighting, with weighting factors, a detection result (e.g., values indicating the number of times each event is detected and the degree of each event) of an event such as vibration, rotation, submersion, disassembly, or modification, and a value indicated (or input) by a user as in Expression 5.

[Expression 5]

DEVICE STATE SCORE=Wₐ·a+W_{b}·b+W_{c}·c+W_{d}·d+Wₑ·e (EXPRESSION 5)
a: VALUE INDICATING NUMBER OF TIMES DEVICE 100 RECEIVES VIBRATION (OR IMPACT), AND DEGREE THEREOF
b: VALUE INDICATING NUMBER OF TIMES DEVICE 100 IS ROTATED, AND DEGREE THEREOF
c: VALUE INDICATING NUMBER OF TIMES DEVICE 100 IS SUBMERGED, AND DEGREE THEREOF (E.G., TIME, ETC.)
d: VALUE INDICATING NUMBER OF TIMES DEVICE 100 IS DISASSEMBLED OR MODIFIED, AND DEGREE THEREOF
e: VALUE INDICATED BY USER
Wₐ TO Wₑ: WEIGHTING FACTORS

As described above, the device state score changes on the basis of a detection result of an event such as vibration, rotation, submersion, disassembly, or modification. For example, as illustrated in FIG. 22, the device state score indicating 1.0 at the time of shipment gradually decreases along with the detection of vibration, submersion, or the like, thereby indicating that the state of the device 100 gradually deteriorates. In addition, the device state score gradually decreases even in a period in which no vibration, submersion, or the like is detected, thereby indicating that the device 100 deteriorates over time. In addition, the device state score also changes in accordance with an instruction of a user, allowing the user to cancel or correct the influence of an event such as vibration by issuing a predetermined instruction. In addition, the user is also able to control the activation or deactivation of a function of updating the device state score by issuing a predetermined instruction. Note that FIG. 22 illustrates merely an example, but the method of changing the device state score is not limited thereto. For example, in a case where such an event happens that improves the state of the device 100, the device state score may increase.

Then, in the step S2204 of FIG. 21, the device 100 calculates a reliability score that is an index value of the reliability of the device state score. More specifically, as in Expression 6, the analysis unit 120 calculates a reliability score by summing the values obtained by weighting, with weighting factors, a value indicating the recording period of a device state score (synonymous with the recording period of an event), a value indicating the proportion of the recording period of a device state score to the use period of the device 100, and a value indicating the number of sensors (detectors) used to calculate a device state score.

[Expression 6]

RELIABILITY SCORE=Tₐ·a+T_{b}·b+T_{c}·c (EXPRESSION 6)
a: VALUE INDICATING RECORDING PERIOD OF DEVICE STATE SCORE (SYNONYMOUS WITH RECORDING PERIOD OF EVENT)
b: VALUE INDICATING PROPORTION OF RECORDING PERIOD OF DEVICE STATE SCORE TO USE PERIOD OF DEVICE 100
c: VALUE INDICATING NUMBER OF SENSORS (DETECTORS) USED TO CALCULATE DEVICE STATE SCORE
Tₐ TO T_{c}: WEIGHTING FACTORS

Note that the operation described above is merely an example, and may be changed as appropriate. For example, the above-described event used to calculate the device state score may be changed as appropriate. More specifically, the event used to calculate the device state score is not limited to the above, but may be any event as long as the event influences the state of the device 100. In addition, information regarding the use frequency of the device 100, information regarding the number of times the device 100 is used, information regarding a user who has used the device 100, or the like (e.g., user article use score or the like) may be taken into consideration. In addition, the above-mentioned element used to calculate the reliability score may also be changed as appropriate. More specifically, the element used to calculate the reliability score may be any element as long as the element influences the reliability of the device state score.

In addition, the device 100 is able to authenticate a user by the method described above, and the device 100 may thus discriminate and calculate the device state score or the reliability score for each user. More specifically, the device 100 may specify a period in which each user uses the device 100, and calculate a device state score or the like on the basis of an event or the like such as vibration happening in each period.

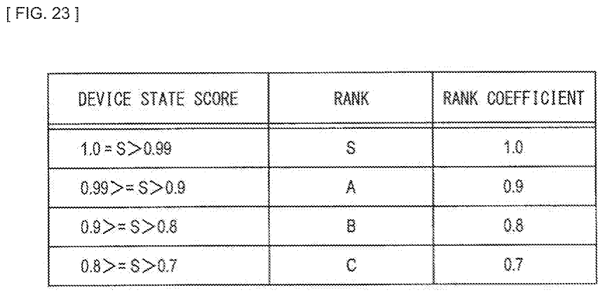

A user (e.g., including the seller or lender of the device 100) is able to properly manage each device 100 by using the device state score calculated by the operation described above. For example, as illustrated in FIG. 23, the rank (in this example, S rank to C rank) of the device 100 may be determined on the basis of the range in which the device state score is included. This allows a lender to lend the devices 100 in ranks that are different in accordance with borrowers when lending the devices 100. For example, in a case where a borrower is highly likely to carelessly handle the device 100 (i.e., in a case where the user article use score of the borrower is low), the lender is able to take countermeasures such as lending the device 100 in lower rank.

In addition, classifying the devices 100 into a plurality of ranks makes it possible to make the management methods simpler than the management methods in a case where the device state scores are used as they are. More specifically, in a case where the device state scores are used as they are, a user has to establish a management method for each device state score. In contrast, in a case where the devices 100 are classified into a plurality of ranks, a user only has to establish a management method for each rank, making the management methods simpler.

In addition, as described above, the selling price (or rental price) of the device 100 may be set on the basis of the device state score. At this time, as illustrated in FIG. 23, a coefficient (in this example, 0.7 to 1.0) used to set the selling price or the like may be determined on the basis of the range including the device state score (the following refers to the coefficient as “rank coefficient”).

Next, the method of setting the selling price (or rental price) of the device 100 is described. For example, the selling price or the like of the device 100 may be a price obtained by multiplying the device state score by a normal used product price (note that it is assumed that device state score is expressed as 0.0 to 1.0) as in Expression 7. Here, the normal used product price may be, for example, the selling price of the unused device 100, and the normal used product price is not limited thereto. This causes a lower selling price (or rental price) to be set for the device 100 in a more unfavorable state.

[Expression 7]

SELLING PRICE=DEVICE STATE SCORE×NORMAL USED PRODUCT PRICE (EXPRESSION 7)

In addition, the selling price or the like of the device 100 may be a price obtained by multiplying the device state score, the demand coefficient, the index value of aging deterioration, and the new product price as in Expression 8 (i.e., the normal used product price may be a price obtained by multiplying the demand coefficient, the index value of aging deterioration, and the new product price). Here, it is sufficient if the demand coefficient is any value indicating the demand of the device 100 in the market at the time when the device 100 is sold (or lent). In addition, it is sufficient if the index value of aging deterioration is any index value indicating aging deterioration (e.g., deterioration caused in a period in which the device 100 is stored without being used) that does not result from an event such as vibration.

[Expression 8]

SELLING PRICE=DEVICE STATE SCORE×(DEMAND COEFFICIENT×INDEX VALUE OF AGING DETERIORATION×NEW PRODUCT PRICE) (EXPRESSION 8)

In addition, the selling price or the like of the device 100 may be a price obtained by multiplying the rank coefficient by the normal used product price as in Expression 9.

[Expression 9]

SELLING PRICE=RANK COEFFICIENT×NORMAL USED PRODUCT PRICE (EXPRESSION 9)

Note that the methods of setting a selling price or the like are not limited to the above. For example, the elements (e.g., each coefficient, normal used product price, new product price, or the like) used in the respective expressions described above may be omitted or changed as appropriate. More specifically, Expression 8 omits the demand coefficient and the index values of aging deterioration, and the selling price may be thereby calculated by multiplying the device state score by the new product price. In addition, applying the method described above may cause the purchase price of the device 100 to be set.

### 4-9. Calculation of User Article Use Score

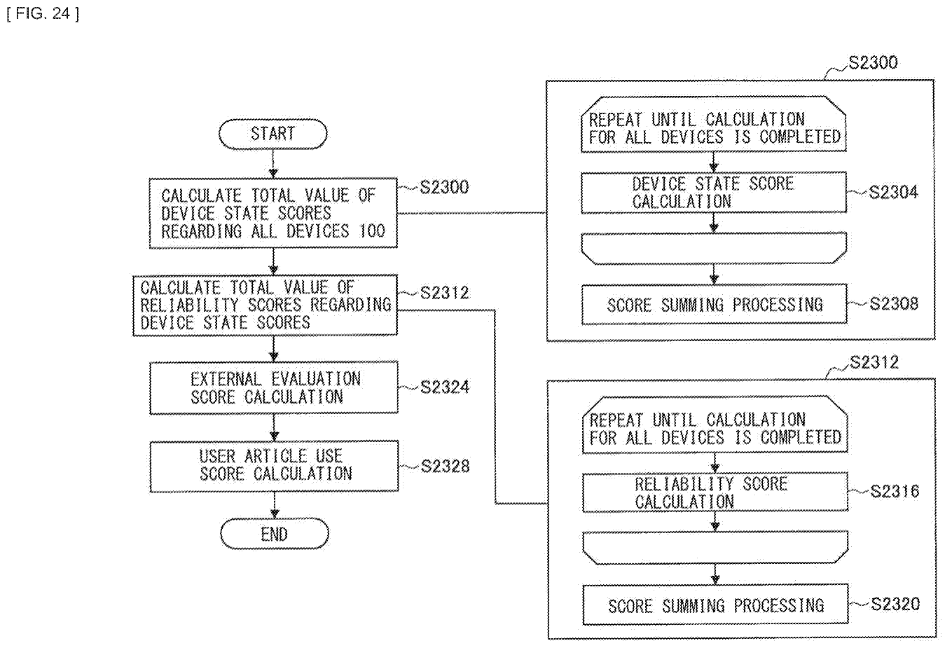

Next, referring to FIG. 24, an operation of calculating a user article use score is described.

In step S2300, the analysis unit 120 calculates the total values of the device state scores regarding all the devices 100 used by a user in the past. More specifically, the analysis unit 120 repeatedly performs processing of performing the calculation of Expression 5 above on all the devices 100 used by a user in the past in step S2304. Thereafter, in step S2308, the analysis unit 120 then performs processing of summing the device state scores regarding all the devices 100.

Here, a method of specifying all the devices 100 used by a user in the past is described. The device 100 is able to specify all the devices 100 used by a user in the past and the periods in which the user has used the respective devices 100, by performing user authentication as described above. Therefore, in step S2304, the analysis unit 120 is able to calculate the device state score of each device 100 on the basis of an event or the like such as vibration happening in the period in which the user has used each device 100. This properly reflects, in each user article use score, how each user has handled the device 100 even in a case where the one device 100 has been used by a plurality of users in the past.

In step S2312, the analysis unit 120 calculates the total value of the reliability scores regarding the device state scores. More specifically, the analysis unit 120 repeatedly performs processing of performing the calculation of Expression 6 above on all the devices 100 used by a user in the past in step S2316. Thereafter, in step S2320, the analysis unit 120 then performs processing of summing the reliability scores regarding all the devices 100.

In step S2324, the analysis unit 120 calculates an external evaluation score that is an index value indicating the overall evaluation of a user based on information provided from the external system. More specifically, the analysis unit 120 acquires some evaluation regarding a user provided from the external system, and calculates the external evaluation score, for example, by summing the values obtained by weighting the evaluation with a weighting factor. Here, the external system may be, for example, an insurance system that provides risk information of the user on the basis of the user's disease history, accident history, and the like, a credit card system that provides risk information indicating that the user falls behind with payment on the basis of the user's payment history and the like, or the like. Note that the external system and the information provided from the external system are not limited to thereto. In addition, the method of calculating the external evaluation score is not particularly limited. For example, the external evaluation score may be calculated by inputting the information provided from the external system to a predetermined arithmetic expression.

In step S2328, the analysis unit 120 calculates a user article use score on the basis of the total value of device state scores, the total value of reliability scores, and the external evaluation score. More specifically, the analysis unit 120 calculates a user article use score, for example, by summing the values obtained by weighting these scores with weighting factors.

As described above, the user article use score is calculated by taking not only the device state scores, but also the reliability scores indicating the reliability into consideration. This allows the analysis unit 120 to calculate an accurate user article use score even in a case where the accuracy of the device state scores is low. In addition, as described above, the user article use score is calculated by taking, into consideration, the external evaluation score based on the information provided from the external system. This allows the analysis unit 120 to improve the accuracy of a user article use score as compared with a case where the score is calculated on the basis of only the information in the present system.

Note that the operation described above is merely an example, and may be changed as appropriate. For example, the analysis unit 120 may calculate a user article use score by using, for the calculation, the average value or the like of the device state scores or the reliability scores instead of the total value thereof.

In addition, the user article use score may be calculated for each category of the device 100. The contents of a category of the device 100 have been described above. This allows the device 100 to calculate a more proper user article use score even in a case where a category of the device 100 changes whether or not a user is able to properly (or carefully) use the device 100. For example, the device 100 is able to calculate a more proper user article use score even in a case where a certain user carefully handles a “camera”, but carelessly handles “stationery”, a case where a certain user carefully handles a “public object”, but carelessly handles a “private object”, or the like.

Here, the rental price (or selling price) of the device 100 may be set on the basis of not only the device state score, but also the user article use score. For example, the rental price or the like of the device 100 may be a price obtained by dividing the normal rental price by the user article use score as in Expression 10 (note that a case is assumed where the user article use score is expressed as 0.0 to 1.0). Here, the normal rental price may be, for example, a rental price for a favorable user, and is not limited thereto. This causes a lower rental price (or selling price) to be set for a user having a higher user article use score (e.g., carefully handling the device 100).

$$\begin{matrix}[ Expression 10 ] & \\ RENTAL PRICE = \frac{NORMAL RENTAL PRICE}{USER ARTICLE USE SCORE} & ( EXPRESSION 10 )\end{matrix}$$

In addition, the rental price or the like of the device 100 may be a price obtained by dividing the value obtained by multiplying the rank coefficient by the normal rental price by the user article use score as in Expression 11. This causes a price to be set that takes even the state of the device 100 into consideration.

$$\begin{matrix}[ Expression 11 ] & \\ RENTAL PRICE = \frac{\begin{matrix}RANK COEFFICIENT \times \\ NORMAL RENTAL PRICE\end{matrix}}{USER ARTICLE USE SCORE} & ( EXPRESSION 11 )\end{matrix}$$

Note that the methods of setting a rental price (or selling price) are not limited to the above. In addition, applying the method described above may cause the purchase price of the device 100 to be set. In addition, the rank of the device 100 to be lent may be changed for each user on the basis of the user article use score.

Here, as described above, the use of the user article use score allows the rental price or the like of the device 100 to be changed for each user, or allows the rank of the device 100 that is lent to be changed for each user. However, for example, a favorable user may borrow the device 100 (or the device 100 in high rank) at low price, and allow an unfavorable user to use it.

At this time, the device 100 is able to authenticate a user by the method described above, and perform a predetermined operation in a case where it is detected that the borrower and the user are different. For example, the device 100 is able to be locked and disabled, warn a user, notify a lender, reset the rental fee according to a user, and the like. Note that the operations of the device 100 in a case where it is detected that a borrower and a user are different are not limited thereto.

### 5. VARIOUS UI

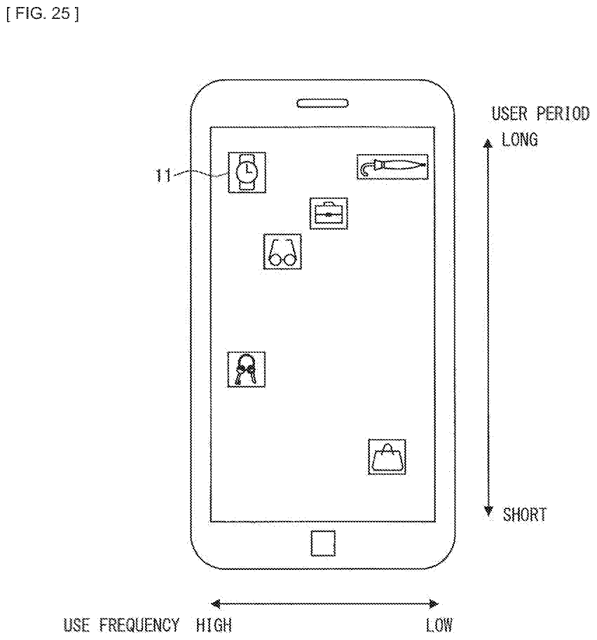

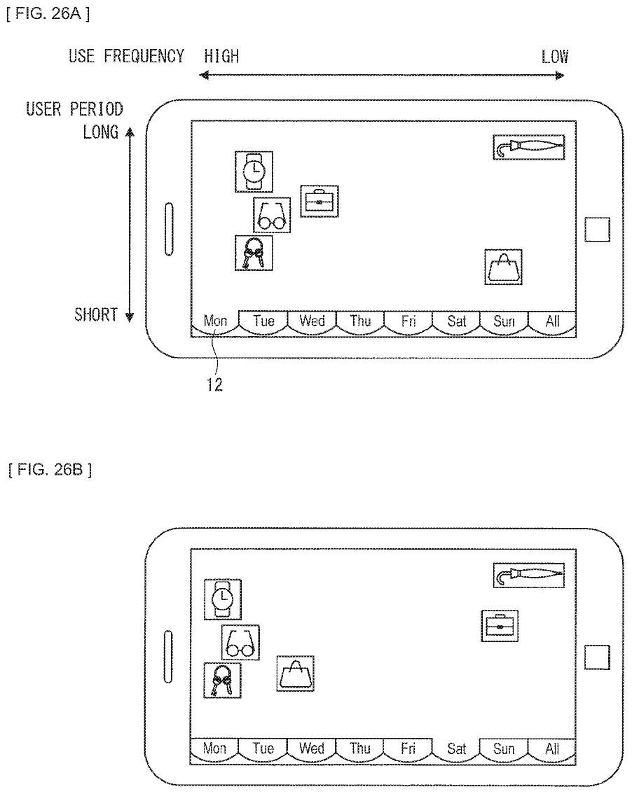

The operation of the device 100 has been described above. Next, referring to FIGS. 25 to 39, examples of various UI regarding the device 100 are described.

In the present disclosure, a user is able to more properly manage the device 100 by using any information processing device. The information processing device used to manage the device 100 is not particularly limited. For example, the information processing device may be any device such as a smartphone, a PC (Personal Computer), a portable game console, a portable music player, or a camera that is able to communicate with the device 100, or may be the device 100 itself (or an apparatus in which the device 100 is incorporated). The following describes, as an example, a case where the information processing device used to manage the device 100 is the device 100 itself, which is a smartphone.

The device 100 is able to display any statistical information on a display. For example, as illustrated in FIG. 25, the device 100 indicates the use period of each device 100 in the vertical direction of the display, indicates the use frequency of each device 100 in the horizontal direction, and disposes an icon 11 of each device 100, thereby making it possible to display the use period and use frequency of each device. Note that FIG. 25 illustrates merely an example, and the example may be changed as appropriate. For example, the statistical information indicated in the vertical direction and horizontal direction of the display may be changed, or the contents of the icon 11 of each device 100 may be changed.

In addition, as illustrated in FIG. 26, the device 100 is also able to display any statistical information (e.g., use frequency, use period, etc.) of the device 100 for each day of the week. Selecting a day-of-week tab 12 allows a user to select the day of the week for which the statistical information is desired to be confirmed (26A illustrates that Monday is selected and 26B illustrates that Saturday is selected).

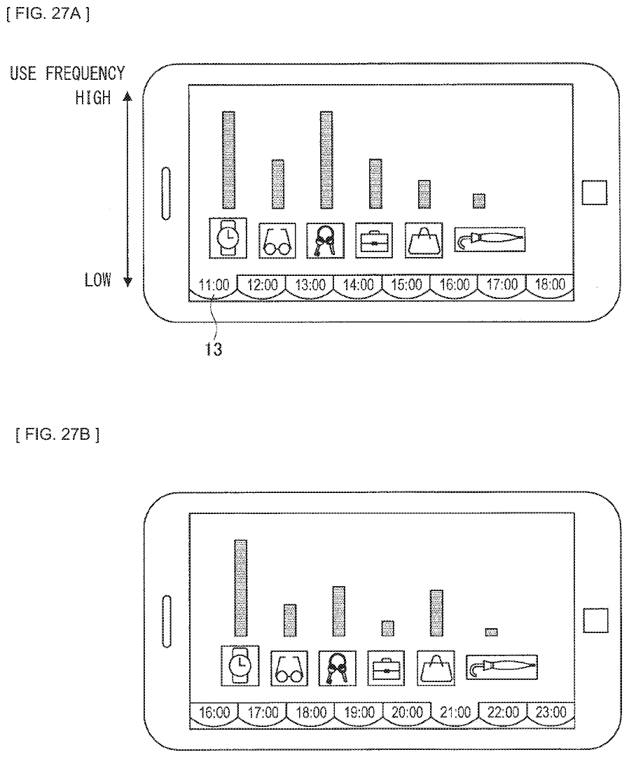

In addition, as illustrated in FIG. 27, the device 100 is also able to display any statistical information (e.g., use frequency, use period, etc.) of the device 100 on a time basis. Selecting a time tab 13 allows a user to select the time for which the statistical information is desired to be confirmed (27A illustrates that the time from 11:00 to 12:00 is selected, and 27B illustrates that the time from 21:00 to 22:00 is selected). Note that, in FIG. 27, the device 100 displays use frequency as a bar graph for each device 100. In this way, the device 100 may display statistical information by using any graphs, tables, diagrams, or the like.

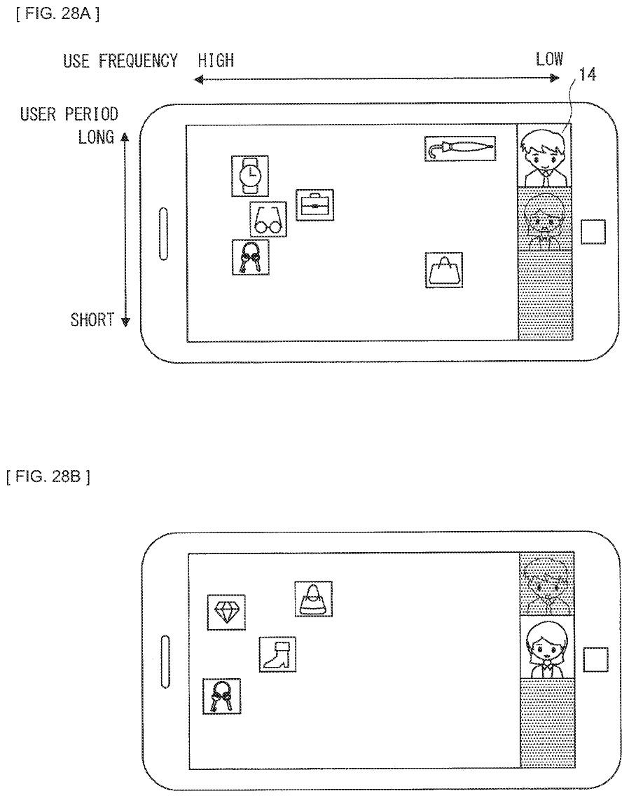

In addition, as illustrated in FIG. 28, the device 100 is also able to display any statistical information (e.g., use frequency, use period, etc.) of the device 100 for each user. Selecting a user tab 14 allows a user is able to select a user for whom the statistical information is desired to be confirmed (28A illustrates that a male user is selected, and 28B illustrates that a female user is selected). This allows, for example, parents to manage the device 100 of a child.

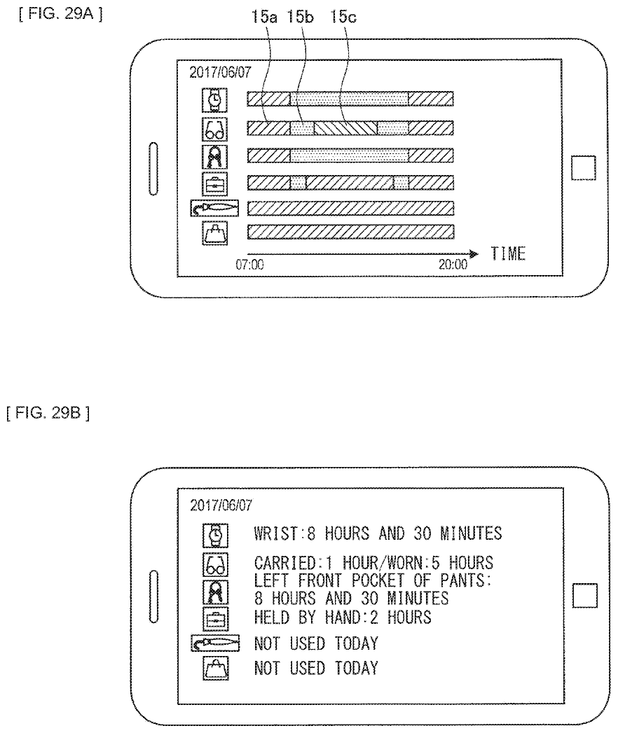

In addition, as illustrated in FIG. 29, the device 100 is able to display the carried state of each device 100 on a daily basis. A user is able to confirm the carried state of each device 100 in a predetermined day in chronological order as illustrated in 29A. Note that, as illustrated in 29A, the device 100 is able to indicate the carried state of each device 100, for example, by switching texture (e.g., for glasses, 15a indicates a “non-carried state”, 15b indicates a “carried state and non-worn state”, and 15c indicates a “worn state”). In addition, a user is able to confirm the summary of the carried states of each device 100 in a predetermined day as illustrated in 29B.

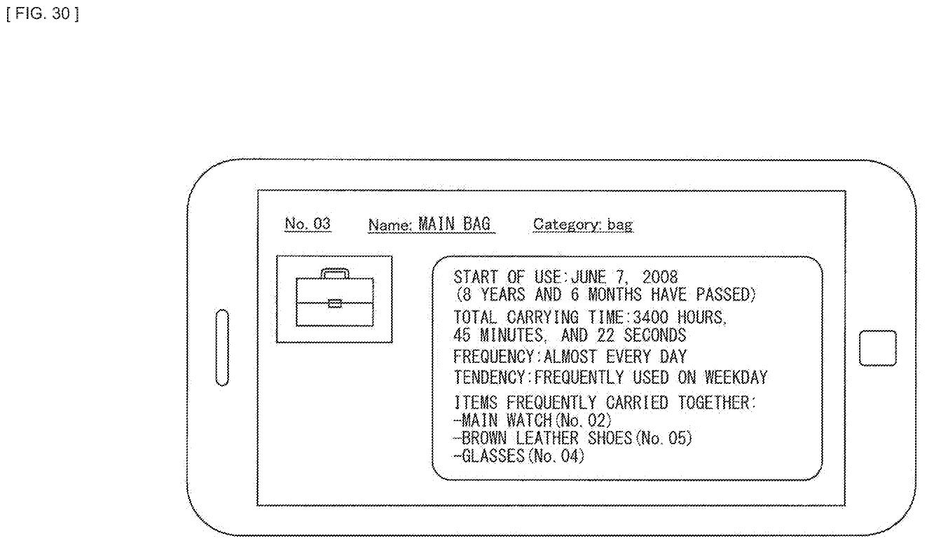

In addition, as illustrated in FIG. 30, the device 100 is able to display the carried-history information of each device 100. The displayed carried-history information has any contents, but, for example, as illustrated in FIG. 30, the start date of use, the total carrying time (total use time), the carrying frequency (use frequency), and the carrying tendency (including information regarding the other device 100 carried together) may be displayed.

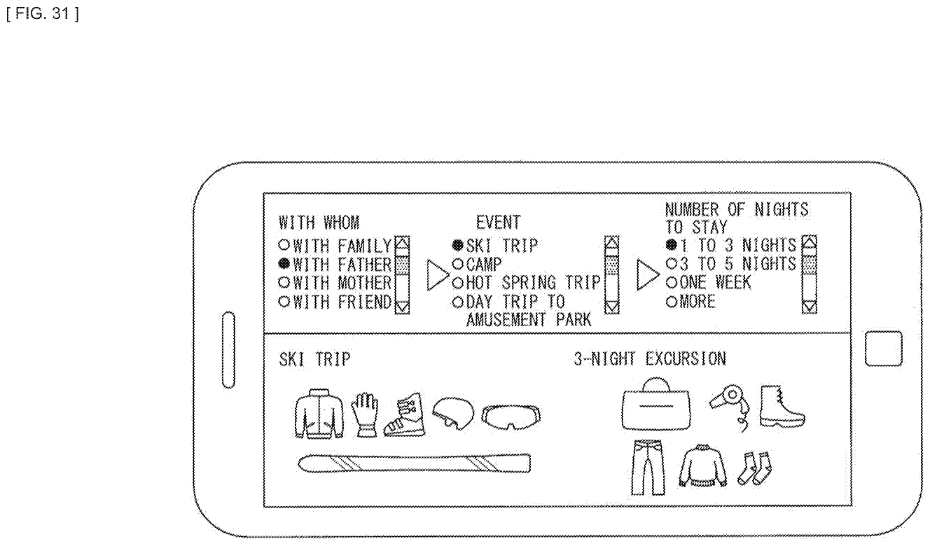

In addition, as illustrated in FIG. 31, the device 100 may recommend the device 100 (which may include an article other than the device 100) that a user should carry (or wear) for each event. The device 100 is able to recommend the device 100 that a user should carry (or wear) on the basis of a category, carried-history information, and the like of each device 100, on the basis of various conditions such as an accompanying person, event contents, and a stay period inputted by the user.

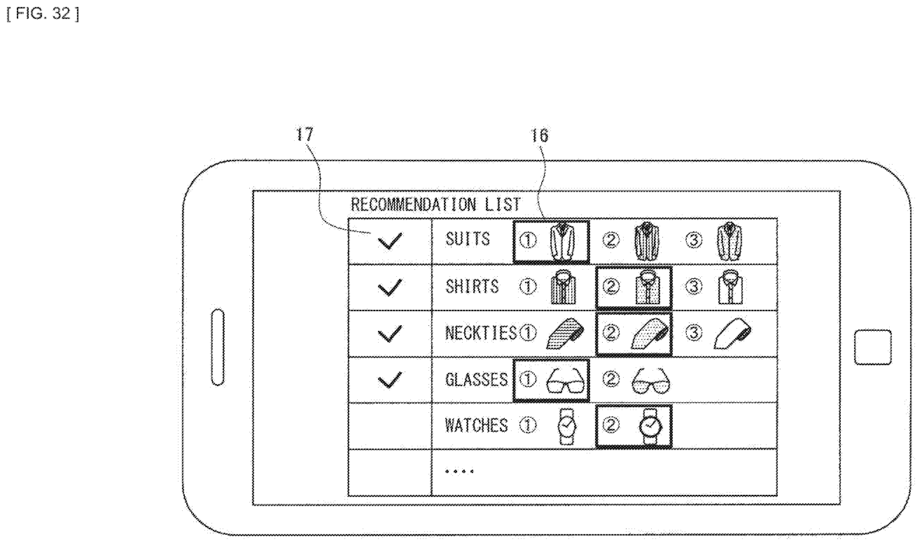

In addition, as illustrated in FIG. 32, the device 100 may recommend the device 100 that should be carried (or worn) for each category. More specifically, the device 100 generates a carried-device list by performing action prediction for a user on the basis an action history or the like. Then, as illustrated in FIG. 32, the device 100 displays the list for each of the categories such as “suit”, “shirt”, “necktie”, “glasses” and “watch”. At this time, the device 100 imparts a predetermined mark 16 to the device 100 recommended in each category. Here, the methods of determining the recommended device 100 are not particularly limited. For example, the device 100 may determine the device 100 to be recommended on the basis of a preference of a user or an action history of a user, or may determine the device 100 to be recommended on the basis of a combination of colors and patterns that is generally considered favorable. In addition, the device 100 dynamically changes the device 100 to be recommended as a user carries (or wears) the device 100 in each category. These operations allow the user to carry (or wear) the device 100 without worrying about the combination, and avoid leaving an object behind. Note that, as illustrated in FIG. 32, a check mark 17 may be displayed on a category of the device 100 carried (or worn) by a user. The UI of FIG. 32 may be changed as appropriate. In addition, the list of FIG. 32 is not generated on the basis of action prediction, but may be generated on the basis of a user input.

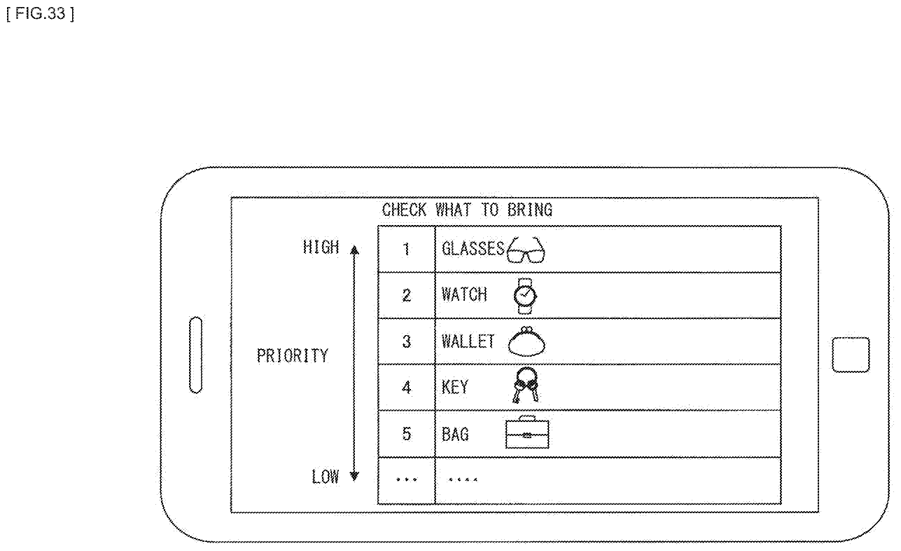

In addition, as illustrated in FIG. 33, the device 100 may display a list (or a list of objects left behind) of the devices 100 that should be carried (or worn) together with the priority. More specifically, the device 100 generates a carried-device list by performing action prediction for a user on the basis an action history or the like. Then, the device 100 outputs a list (or a list of objects left behind) of the devices 100 that should be carried, by removing the device 100 that has already been carried by a user from the carried-device list. At this time, the device 100 calculates the priority of each device 100. The methods of calculating the priority are not particularly limited. For example, higher priority may be set for the device 100 having higher probability of being carried by a user, on the basis of an action history, etc. In addition, higher priority may be set for the device 100 that is carried by a user at earlier timing, on the basis of an action history, etc. In addition, the example of FIG. 33 assumes that the device 100 carried by a user is deleted (disappears) from a list each time, but this is not limitative. In addition, the contents or order of the list may be dynamically changed in accordance with a change in the priority of each device 100. The UI of FIG. 33 may be changed as appropriate.

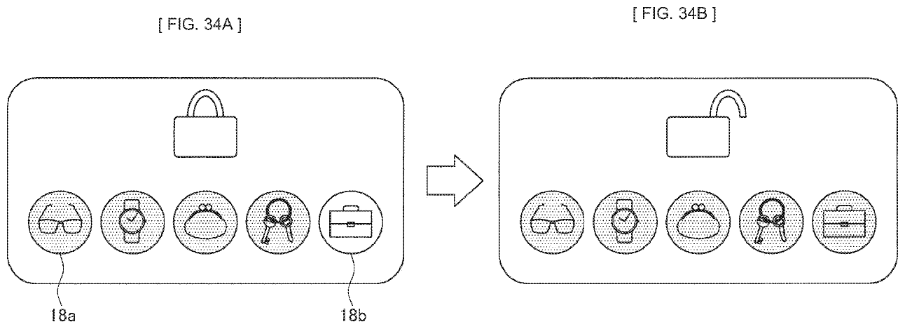

In addition, as described above, the device 100 is able to perform user authentication by using sensing data, and allow for unlocking or the like on the basis of a result of the authentication. Therefore, the device 100 is able to provide a user with a combination of the unlocking function and the function of a notification of an object left behind. More specifically, the device 100 allows for unlocking in a case where user authentication results in success and it is possible to confirm that there is no object left behind. In this case, the device 100 may provide UI as illustrated in FIG. 34 to the user. More specifically, the device 100 necessary for unlocking may be illustrated as an icon. Note that, in the example of FIG. 34, at the timing at which a user carries the device 100, the icon of the device 100 transitions from the non-highlighted state (state of an icon 18b in 34A) to the highlighted state (state of an icon 18a of 34A). Then, as illustrated in 34B, in a case where the icons of all the devices 100 each enter the highlighted state (i.e., in a case where a user carries all the devices 100), unlocking is performed (note that it is assumed that user authentication results in success). The UI of FIG. 34 may be changed as appropriate.

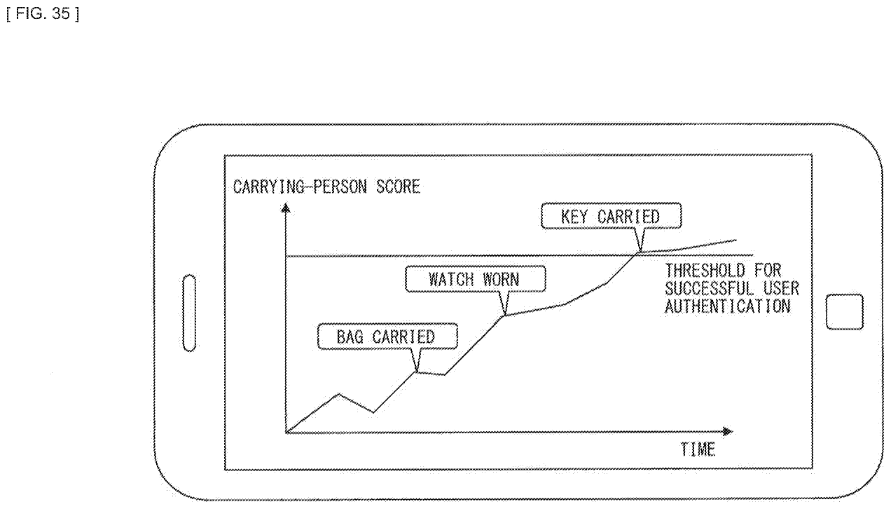

In addition, the device 100 may provide a user with UI indicating the situation of user authentication using sensing data. More specifically, as described above, the device 100 may perform user authentication on the basis of a combination of the devices 100 carried by a user, the order in which the devices 100 are carried, or a carrying method, or the like. In this case, as illustrated in FIG. 35, the device 100 may display a graph illustrating the situation of the user authentication. The example of FIG. 35 displays a line chart illustrating a temporal change in the carrying-person score (or the value corresponding to the carrying-person score), and a threshold for successful user authentication. In the example of FIG. 35, the carrying-person score exceeds the threshold at the timing at which a user carries a bag, a watch, and then a key, resulting in successful user authentication. This UI allows the user to sufficiently know the situation of the user authentication. Note that the UI indicating the situation of user authentication is not limited to the example of FIG. 35.

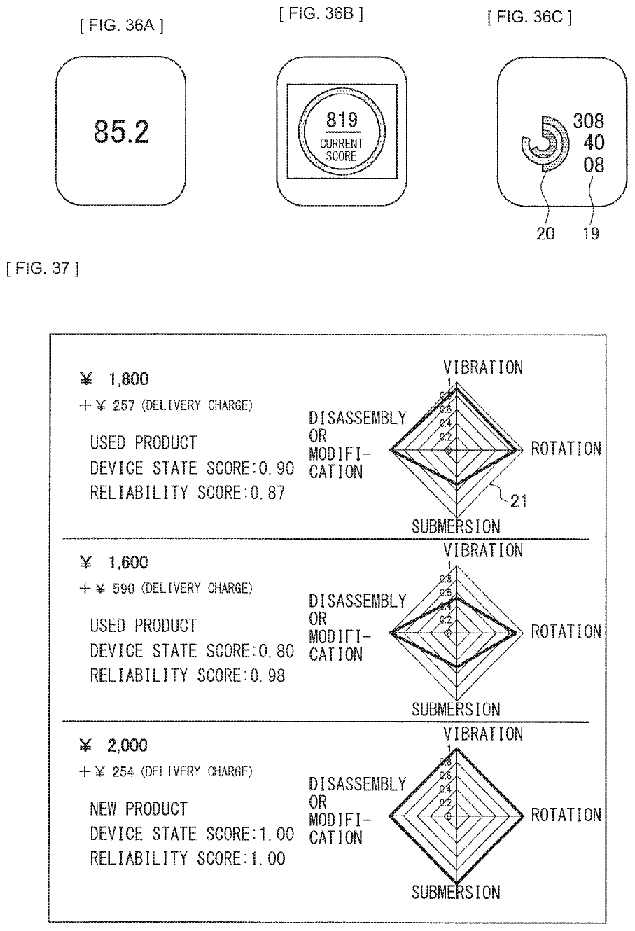

For example, as illustrated in 36A and 36B of FIG. 36, the carrying-person score (or the value corresponding to the carrying-person score) may be displayed in a text format. In addition, as illustrated in 36C, the device 100 may decompose the carrying-person score into a plurality of elements (e.g., an action recognition result, a carried-position recognition result, and the like), and display the value of each element in a text format 19 or as a progress bar 20.

In addition, as described above, the selling price or rental price of the device 100 may be set on the basis of the device state score, the reliability score, or the user article use score. Next, a specific example of UI that displays the selling price or the like of the device 100 is then described. For example, in a case where a user purchases the device 100 from a predetermined website, a screen as illustrated in FIG. 37 may be displayed. More specifically, as illustrated in FIG. 37, such a screen may be displayed that indicates the selling price of each device 100, whether or not each device 100 is a new (unused) product, the device state score, and a radar chart 21 indicating the influence of an event such as vibration used when calculating the reliability score and the device state score. In this example, the selling price of each device 100 is a price obtained by multiplying the device state score by the new product price (in this example, ¥2,000).

Providing this screen facilitates a user to select the desired device 100. More specifically, a user is able to select the desired device 100 by taking, into consideration, the balance between the state of the device 100 and the selling price thereof. In addition, the user also is then able to take, into consideration, even a reliability score indicating the reliability of the device state score. Further, the user is able to determine whether or not an event happening to each device 100 falls within an allowable range, on the basis of the radar chart 21. For example, when purchasing the device 100 having low water resistance, the user is able to preferentially select the device 100 to which the event of submersion has not happened. The UI of FIG. 37 may be changed as appropriate.

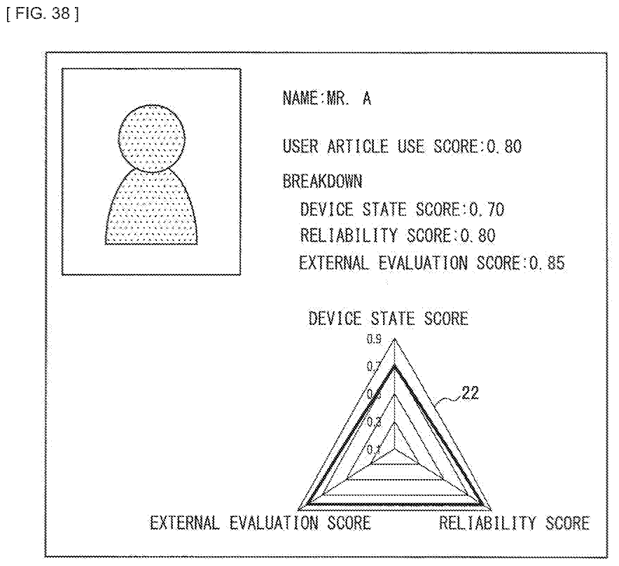

In addition, there may be provided UI that allows a user to confirm the user article use score or the like of the user himself or herself. For example, as illustrated in FIG. 38, the name of a user, the user article use score, the various scores (the device state score, the reliability score, and the external evaluation score) used to calculate the user article use score, and a radar chart 22 indicating these scores may be displayed. Note that the device state score and reliability score in FIG. 38 are values (values obtained by dividing the total values by the number of devices) obtained by averaging the respective total values calculated in steps S2300 and S2304 in FIG. 24, but are not limited thereto. Providing this screen allows a user to confirm the user article use score of the user himself or herself at any time. In addition, the user is able to confirm the various scores used to calculate the user article use score, and the user is thus able to recognize the ground for the user article use score. In addition, a lender considering whether or not to lend the device 100 to the user may be able to use the screen. This allows the lender to determine whether or not to lend the device 100 on the basis of the user article use score and the ground for that. The UI of FIG. 38 may be changed as appropriate.

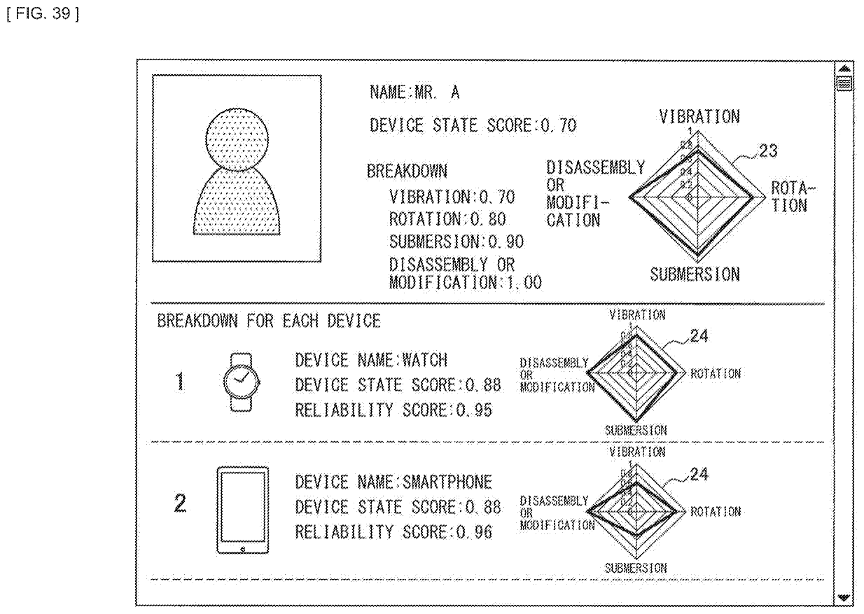

Here, as described above, the user article use score is calculated on the basis of the device state scores regarding all the devices 100 used by a user in the past. Therefore, there may be provided UI that makes it possible to confirm the device state scores and the like of all the devices 100 used by the user in the past. For example, as illustrated in FIG. 39, the name of a user, the device state score, the value indicating the influence of various events used to calculate the device state score, a radar chart 23 indicating these values, and the breakdown of each device 100 (in this example, the device name regarding each device 100, the device state score, and a radar chart 24 indicating the influence of various events used to calculate the reliability score and the device state score are displayed) may be displayed. Providing this screen allows the user to recognize the ground for the device state score used to calculate the user article use score of the user himself or herself. In addition, similarly to FIG. 38, a lender considering whether or not to lend the device 100 to the user may be able to use the screen. For example, a lender is able to determine not to lend the device 100 having low water resistance to a user who frequently submerges the device 100. The UI of FIG. 39 may be changed as appropriate.

Note that the display contents described above are merely an example, and may be changed as appropriate. For example, the device 100 may display the results or interim progress reports of the various kinds of processing described above, information used in the various kinds of processing, and the like.

### 6. CONCLUSION

As described above, the device 100 according to the present disclosure is able to perform user authentication on the basis of the carried state of the device 100 by a user. For example, the device 100 is able to perform user authentication on the basis of a combination of the devices 100 carried by the user, the carrying methods, the timing and order for the devices 100 to be carried, and the like.

In addition, the device 100 is able to perform action prediction for a user on the basis of the carried state of the device 100 by the user, and is also able to, for example, notify the user of an excess or deficiency (e.g., objects left behind, unnecessary objects, etc.) of the carried devices 100 on the basis of a result of the action prediction.

In addition, the device 100 is able to recognize the relevance between two or more users on the basis of the sharing situation of the device 100 by the respective users.

In addition, the device 100 is able to recognize a category of the own device on the basis of the carried state of the device 100 by a user, and effectively use the carried-history information acquired from the other device 100 having the same category or a category in a predetermined relation.

In addition, the device 100 is able to properly evaluate the state of the device 100 by storing the past use situation by a user. More specifically, the device 100 is able to calculate a device state score that is an index value which makes it possible to evaluate the state of the own device, and a reliability score that is an index value indicating the reliability of the score.

In addition, the device 100 is able to calculate a user article use score indicating how properly a user is able to use the device 100, on the basis of the use situation or the like of each device 100 by the user. The device state score, the reliability score, or the user article use score may be used, for example, to set the selling price (or the rental price) of the device 100.

In addition, in the sharing economy service or the like, the device 100 is able to detect that a borrower and an actual user are different from each other.

In addition, the device 100 also is able to provide a user with various UI regarding the scores and the like of the device 100 or the user.

A preferred embodiment(s) of the present disclosure has/have been described above in detail with reference to the accompanying drawings, but the technical scope of the present disclosure is not limited to such an embodiment(s). It is apparent that a person having ordinary skill in the art of the present disclosure can arrive at various alterations and modifications within the scope of the technical idea described in the appended claims, and it is understood that such alterations and modifications naturally fall within the technical scope of the present disclosure.

For example, the respective devices 100 share the various kinds of processing described above at any proportion. For example, the other device 100 may transmit raw sensing data to the device 100 that performs the various kinds of processing described above, and the various kinds of processing may be achieved by the device 100 that receives the data. In addition, the other device 100 may transmit data subjected to a portion of the various kinds of processing to the device 100 that performs the various kinds of processing. This allows each device 100 to reduce the amount of communication data.

In addition, in the various kinds of processing described above such as the action prediction, the person relevance recognition, or the category recognition, the information used for the processing of user authentication (e.g., a combination of the devices 100, the carrying methods of the devices 100, the timing or order for the devices 100 to be carried, and the like) may also be applied as appropriate. For example, action prediction may also be performed using even the carrying method or the like of the device 100.

Furthermore, the effects described herein are merely illustrative and exemplary, and not limiting. That is, the technique according to the present disclosure can exert other effects that are apparent to those skilled in the art from the description herein, in addition to the above-described effects or in place of the above-described effects.

It should be noted that the following configurations are also fall within the technical scope of the present disclosure.

(1)

An information processing device including

an authentication unit that authenticates a user on the basis of information regarding carried states of two or more devices by the user, the information being acquired from the devices.

(2)

The information processing device according to (1), in which the authentication unit performs the authentication on the basis of a relationship between the carried states of the devices.

(3)

The information processing device according to (2), in which the authentication unit performs the authentication on the basis of a combination of the devices.

(4)

The information processing device according to (2) or (3), in which the authentication unit performs the authentication on the basis of a carrying method of the device.

(5)

The information processing device according to any one of (2) to (4), in which the authentication unit performs the authentication on the basis of timing or order for the devices to be carried.

(6)

The information processing device according to any one of (2) to (5), in which the authentication unit performs the authentication on the basis of the relationship at a certain time slot, a certain time point, or at a time of a certain action.

(7)

The information processing device according to any one of (1) to (6), in which the authentication unit performs the authentication on the basis of the information acquired from the device carried by the user.

(8)

The information processing device according to any one of (1) to (7), in which the authentication unit ensures identification of the user by processing with a lighter load than a load of the authentication after the authentication results in success.

(9)

The information processing device according to any one of (1) to (8), further including an action prediction unit that performs action prediction for the user on the basis of the information.

(10)

The information processing device according to (9), further including a recommendation unit that outputs a device recommended to be carried on the basis of the action prediction.

(11)

The information processing device according to any one of (1) to (10), further including a relevance recognition unit that recognizes relevance between the two or more users who share the device on the basis of the information.

(12)

The information processing device according to (11), in which the relevance recognition unit recognizes the relevance on the basis of importance of the device or a number of the devices that are shared.

(13)

The information processing device according to any one of (1) to (12), further including a category recognition unit that recognizes a category for classifying the device on the basis of the information.

(14)

The information processing device according to (13), further including a control unit that controls cooperation with another device on the basis of the category.

(15)

The information processing device according to (14), in which the control unit shares the information with the other device on the basis of the category.

(16)

The information processing device according to any one of (1) to (15), further including a registration unit that registers the user as an owner of the device.

(17)

An information processing device according to (16), further including a control unit that controls predetermined processing in a case where the device is carried or used by a person other than the owner or a person other than a borrower.

(18)

The information processing device according to any one of (1) to (17), further including a device state calculation unit that calculates a value indicating a state of the device on the basis of an event that has happened to the device in past.

(19)

An information processing device according to (18), in which the device state calculation unit calculates reliability of a value indicating the state or quality of the device on the basis of a recording period of the event.

(20)

The information processing device according to (19), further including a user appropriateness calculation unit that calculates a value indicating appropriateness of use of the device by the user on the basis of the value indicating the state of the device used by the user in the past, and the reliability.

(21)

The information processing device according to (20), in which the user appropriateness calculation unit also calculates the value indicating the appropriateness on the basis of information regarding evaluation of the user provided from an external system.

(22)

The information processing device according to (1), further including a control unit that controls display of at least one of information regarding the current or past carried state, information regarding the device recommended to be carried by the user, information regarding a situation of the authentication, information regarding a state or quality of the device, information regarding reliability of a value indicating the state or quality of the device, information indicating appropriateness of use of the device by the user, or information regarding evaluation of the user provided from an external system.

(23)

An information processing method that is executed by a computer, the information processing method including

authenticating a user on the basis of information regarding carried states of two or more devices by the user, the information being acquired from the devices.

(24)

A program for causing a computer to implement

authenticating a user on the basis of information regarding carried states of two or more devices by the user, the information being acquired from the devices.

### REFERENCE SIGNS LIST

100: Device
110: Acquisition unit
120: Analysis unit
130: Storage unit
140: Communication unit
150: Control unit

1. An information processing device comprising
an authentication unit that authenticates a user on a basis of information regarding carried states of two or more devices by the user, the information being acquired from the devices.

2. The information processing device according to claim 1, wherein the authentication unit performs the authentication on a basis of a relationship between the carried states of the devices.

3. The information processing device according to claim 2, wherein the authentication unit performs the authentication on a basis of a combination of the devices.

4. The information processing device according to claim 2, wherein the authentication unit performs the authentication on a basis of a carrying method of the device.

5. The information processing device according to claim 2, wherein the authentication unit performs the authentication on a basis of timing or order for the devices to be carried.

6. The information processing device according to claim 2, wherein the authentication unit performs the authentication on a basis of the relationship at a certain time slot, a certain time point, or at a time of a certain action.

7. The information processing device according to claim 1, wherein the authentication unit performs the authentication on a basis of the information acquired from the device carried by the user.

8. The information processing device according to claim 1, wherein the authentication unit ensures identification of the user by processing with a lighter load than a load of the authentication after the authentication results in success.

9. The information processing device according to claim 1, further comprising an action prediction unit that performs action prediction for the user on a basis of the information.

10. The information processing device according to claim 9, further comprising a recommendation unit that outputs a device recommended to be carried on a basis of the action prediction.

11. The information processing device according to claim 1, further comprising a relevance recognition unit that recognizes relevance between the two or more users who share the device on a basis of the information.

12. The information processing device according to claim 1, further comprising a category recognition unit that recognizes a category for classifying the device on a basis of the information.

13. An information processing device according to claim 1, further comprising a control unit that controls predetermined processing in a case where the device is carried or used by a person other than an owner or a person other than a borrower.

14. The information processing device according to claim 1, further comprising a device state calculation unit that calculates a value indicating a state of the device on a basis of an event that has happened to the device in past.

15. An information processing device according to claim 14, wherein the device state calculation unit calculates reliability of a value indicating the state or quality of the device on a basis of a recording period of the event.

16. The information processing device according to claim 15, further comprising a user appropriateness calculation unit that calculates a value indicating appropriateness of use of the device by the user on a basis of the value indicating the state of the device used by the user in the past, and the reliability.

17. The information processing device according to claim 16, wherein the user appropriateness calculation unit also calculates the value indicating the appropriateness on a basis of information regarding evaluation of the user provided from an external system.

18. The information processing device according to claim 1, further comprising a control unit that controls display of at least one of information regarding the current or past carried state, information regarding the device recommended to be carried by the user, information regarding a situation of the authentication, information regarding a state or quality of the device, information regarding reliability of a value indicating the state or quality of the device, information indicating appropriateness of use of the device by the user, or information regarding evaluation of the user provided from an external system.

19. An information processing method that is executed by a computer, the information processing method comprising
authenticating a user on a basis of information regarding carried states of two or more devices by the user, the information being acquired from the devices.

20. A program for causing a computer to implement
authenticating a user on a basis of information regarding carried states of two or more devices by the user, the information being acquired from the devices.
